(19) United States
(12) Patent Application Publication
(10) Pub. No.: US 2004/0041082 A1
(43) Pub. Date: Mar. 4, 2004

(54) Molecular sensing array

(76) Inventor: Gary R. Harmon, Manassas, VA (US)

Correspondence Address: ASHEN & LIPPMAN, 4385 OCEAN VIEW BOULEVARD, MONTROSE, CA, 91020, US

(21) Appl. No.: 10/306,899

(22) Filed: Nov. 26, 2002

Related U.S. Application Data
(60) Provisional application No. 60/333,931, filed on Nov. 27, 2001.

(51) Int. Cl. H01J 40/14

(52) U.S. Cl. 250/214 R

(57) ABSTRACT

An optical sensor material, sensor system, sensor material preparation method and test method for imaging and nonimaging purpose based on an optical phase-shift material having magnetooptic properties.

This document claims priority of United States provisional patent application, serial No. 60/333,931 filed on Nov. 27, 2001.

### BACKGROUND

1. Field of the Invention

This invention relates generally to sensors; and more particularly to a sensor material, sensor system, sensor method, sensor material preparation method and test method for imaging and nonimaging purpose based on an optical phase-shift material having magnetooptic properties.

2. Related Art

Current art uses semiconductor photosensor arrays (e.g., charge-coupled device (CCD) arrays) for electro-optical imaging. CCDs were invented in 1969. Hughes Aircraft, and then Rockwell International, fabricated CCDs in doped extrinsic silicon detector materials using IRAD and ARPA funding in the early 1970's. These were the first arrays developed for space applications. The first Hughes and Rockwell devices were 32×32 2-D staring arrays. By 1974, NASA produced the first low resolution visible light CCD imagery.

Charged Coupled Devices (CCDs) store incoming photon-produced electrons in “storage wells.” The storage capacity is largely determined by the electric field used for creating the potential wells. The dielectric strength of the silicon sets a limit to the field, which limits the charge storage capacity per C=Q/V. Up to >100,000 electrons can be collected within a well for each pixel and serially clocked from an array to be reconstructed as an image.

FIG. 24 shows three schematic diagrams of a single CCD element, a close-up of a CCD array and a close-up of an interline frame transfer CCD array, respectively. Single CCD building blocks typically range from 2×2 to 24×24 micron pixels, with a thickness range of 15 to 20 microns. Because the single pixels are built into the arrays with analog to digital conversion electronics, image data must be “clocked” by electronic steps to the serial register, then clocked through the output amplifier. Furthermore, conventional interline frame transfer CCD arrays or CMOS technology can reduce pixel size and use semiconductor standards, but it does not eliminate time, power and weight margin consuming analog to digital conversion. FIG. 25 is a graph providing a comparison of the dynamic range of these commonly known sensor types. More comparison information is found in FIG. 26 which address additional sensor parameters.

CCDs, however, are focal plane or pixel limited systems. In a pixel limited system, because all of the detail goes into a single pixel, the size of the individual pixels limits the focal length and as a result resolution is lost as focal length is shortened.

In practice, formidable aberration problems have limited telescope designs to about f/1.2. Other current and programmed prior art CCD limitation include pixel sizes that affect optical focal length and speed (or f/number), array sample rates that affect imaging rates and power consumption for analog to digital conversion. Another major issue with prior art CCD's and other semiconductor photosensor arrays is that communications rates affect imaging rates by unfavorably slowing them down. The same is true for ground processing which affects both the imaging rates and power consumption. Moreover, these communication rates that slow down dissemination of final image products also result in limiting image analysis or significantly slowing them down.

As can now be seen, the related art remains subject to significant problems, and the efforts outlined above—although praiseworthy—have left room for considerable refinement.

### SUMMARY OF THE DISCLOSURE

The present invention introduces such refinement. The invention has at least five independently usable facets or aspects, which will now be introduced.

These aspects or facets, however, do have several elements in common. The common parts will be described first.

In its preferred embodiments, the present invention is an optical phase-shift material. The material includes photon-energized electrons interacting with a magnetic field, a dye film supplying the photoelectrons and a substrate surface for supporting the dye film.

Now in preferred embodiments of a first of the independent aspects or facets of the invention, further includes insulation, wherein the insulation includes means for electron blocking. The electron-blocking means are located within interstitial space of the material. These electron-blocking means include nitrogen-containing polymers used to prepare the material.

In preferred embodiments, the dye film is a photosensitive thin film. The dye film can also be a multilayer photosensitive thin film. The dye has magnetooptical properties which include means for causing birefringence. These properties include a capability for changing ellipticity of polarization of a probing light beam. Thus, the material is sensitive to incoming light in visible, ultraviolet and infrared spectral regions.

In another preferred embodiment, the dye can be made of ferromagnetic atoms.

In yet another preferred embodiment, the material is coated on a nonplanar surface.

In particularly preferred embodiments, the substrate is substantially transparent. Moreover, the substrate surface is can be polished metal, glass, quartz or plastic. The substrate surface can also include one or more microscopic particles. The substrate surface can include means defining one or more cavities. Also, the substrate surface can surround the dye film, forming dye microdroplets.

The dye film in preferred embodiments is made of either pthalocyanines, porphyrins, anthraquinones or perylene derivatives. Yet, in other preferred embodiments, the dye film is selected as either silver nanoparticles with anthraquinone, silver nanoparticles with quinizarin, silver nanoparticles with 1,4 diamnoanthraquinone, silver nanoparticles with oil blue, zinc pthalocyanine, perylene, zinc 2,3,910,16,17,23,24-octakis(octyloxy)-29H,31H-phthalocyanine, iron(II)phthalocyanine, protoporphyrin IX iron(III), 5,10,15,20-tetraphenyl-21H,23H-porphine iron(III)chloride, 5,10,15,20-tetraphenyl-21H,23H-porphine cobalt(III), oil blue, quiniarin 1,4-dihydroxyanthraquinone or N,N′-ditridecyl-3,4,9,10-perylenetetracarboxylic diimide.

In other embodiments, the material includes means for relaxation. The relaxation means include holes recapturing the photon-energized electrons after the electrons enter a higher energy state. The relaxation means substantially restore the material to an initial energy state. In preferred embodiments they substantially restore the material within a time period on the order of 100 microseconds. In more particularly preferred embodiments they substantially restore the material in a time period on the order of 10 microseconds.

The foregoing may be a description or definition of the first facet or aspect of the present invention in its broadest or most general terms. Even in such general or broad form, however, as can now be seen the first aspect of the invention resolves the previously outlined problems of the prior art.

The invention of this application has the advantage that it can reduce the smallest detector element to sub-micron diameters providing nearly a ten-to-twenty-fold reduction in size and ten-to-twenty-fold improvement in photon areal density. This leads directly to much more compact telescopes, digital cameras, imaging spacecraft with wider field of view, low-light/moonlight imaging, and potentially video frame rates and stop motion electro-optical imaging. Because the material used is a layer of photosensitive material and polymer coated substrate in various shapes (including microspheres, or discs) this layer can be shaped for best sensor performance rather than dictating a flat photosensor array. This also contributes to a wider field of view even in existing optical instruments from telescopes to microscopes and non-imaging sensors as well.

Now turning to a second of the independent facets or aspects of the invention includes a sensing system including an optical phase-shift material, means for exposing the optical phase-shift material to a light pattern, and means for detecting a resulting optical-phase shift by the material.

In preferred embodiments the detecting means include means for producing a light beam phase-shifted by the material and a data link transmitting the phase-shifted beam.

In other preferred embodiments of this second facet, the producing means derive the phase-shifted beam from interaction of a reading beam and the material directly, with no intervening electronic stage. The producing means can also include means for imposing a magnetic field on the material to interact with the material and produce the phase shift. Additionally, the producing means can include means for directing a readout beam to the material, to be phase shifted by the material.

In most preferred embodiments the readout beam is a beam from a laser or light-emitting diode. In particularly preferred embodiments the magnetic field produces a force on energetic electrons, wherein the force causes elliptical polarization of light reflected from the readout laser beam. In other embodiments the directing means include means for raster scanning the laser beam. The directing means can also include means for intensity modulating the laser beam.

For use in preferred embodiments as an imaging system the laser beam is detected and applied to reconstruct an image carried in the light pattern. The scanning laser beam substantially instantaneously reads and transmits desired portions of the image. In other preferred embodiments the directing means further include means for adjusting scan rates of the scanning laser beam to aid image motion compensation and smear reduction.

In particularly preferred embodiments of the system the data link includes a downlink from a space-based module to a planetary station or a near-planetary vehicle. The downlink can include means for amplifying, expanding and collimating the phase-shifted beam. These expansion means and collimation means can include a telescope for expanding and collimating the readout transmission.

Additionally, in preferred embodiments the system includes means for optical processing of the phase-shifted beam. These processing means can include means for identifying objects. The identifying means can include means for identifying particular objects which in some embodiments includes manmade objects. The system can also include means for processing the resulting image light to presentation. These processing means include means for annotating the resulting image light.

In particularly preferred embodiments the system has the added feature of automatic means for monitoring resulting image light; wherein the monitoring means are either an annunciator for alerting an operator to the resulting image light, an alarm for alerting an operator to the resulting image light, robotics for carrying out an appropriate response to the resulting image light or an automated task performed in response to the resulting image light.

In preferred embodiments where the system is for use in surveillance, the system further includes optics for focusing light emanating from a desired image, means for reading and transmitting the resulting image light, confocal scanning means for transmitting light to a photodiode or an amplifier, means for amplifying the resulting image light, transmission means includes the data link, means for reconstructing or analyzing the light pattern, means for receiving and displaying the resulting image light, means for processing the resulting image and automatic means for monitoring the resulting image and providing an appropriate response.

Other preferred embodiments include a reading and transmitting means consisting of a scanning laser or a light-emitting diode illumination. In other embodiments the amplification means include a laser telescope amplifier, means for transmitting the light pattern, the transmitting means being either a free space link or fiber optics; and means for receiving the transmitted light pattern, where the receiver is either a receiver telescope or a fiber optics receiver.

The transmitting means in preferred embodiments include an avalanche high-speed photodiode and means including a modulator, a free space link, fiber optics or an electronics line. The receiving and displaying means in preferred embodiments include means for forming panchromatic images, color images, polarimetric images or video images.

In particularly preferred embodiments particularly for forming multiple images in a time series, the system further includes means for reading and transmitting the resulting image light, confocal optics for transmitting the light, means for reconstructing or analyzing the light pattern, and means for receiving the resulting image light. The reading and transmitting means can include either a scanning laser or a light-emitting diode illumination. The receiving means means in preferred embodiments include means for forming panchromatic images, color images, polarimetric images, spectrographic images or video images.

Furthermore, in particularly preferred embodiments of the system, the material includes an array. The array can be substantially seamless. The material can then be coated on a curved surface. The array can be at a focal-surface array. In many embodiments the array has an f/number roughly 1, or smaller. In preferred embodiments the array is cylindrical and is for use in receiverless sensing includes radio frequency to ultraviolet wavelength sensing.

Moreover, in particularly preferred embodiments the material includes dye molecules. The dye molecules can include pixels. The pixels can then be electrostatically localized in an array. In this embodiment the pixels can be reproducibly arranged in the array. The pixels are smaller than light wavelengths emanating from an object to be imaged. In preferred embodiments the pixels are of an order 10 nanometers in size. The pixels can be aligned to polarize light. The pixels can be oriented perpendicularly to the magnetic field.

In other particularly preferred embodiments the optical phase-shifting material is for use in optical switching. The optical switching can include sub-nanosecond optical switching.

In another particularly preferred embodiment, the material is for use in chemical-process monitoring. The chemical-process monitoring can include femtosecond chemical-process monitoring.

In yet another particularly preferred embodiment the material is used as an optical absorber for optical stealth applications. The optical stealth applications can include any of missile technology, aerospace technology, aviation technology, film technology, video technology, stealth technologies, and securities industries.

The foregoing may constitute a definition or description of the second facet or aspect of the present invention in its broadest or most general terms. Even in such general or broad form, however, as can now be seen the second aspect of the invention resolves the previously outlined problems of the prior art.

The focal array has the advantage over the prior art that it can be shaped in three dimensions to permit the use of otherwise difficult anamorphic optical system designs that will permit undistorted low angle reconnaissance and surveillance to the horizon. The second broad area of great improvement is the accomplishment of direct readout of the focal array by a laser (or stable LED) whose light can then be amplified and transmitted to a nearby receiving instrument or to a faraway receiving ground station. This approach eliminates heavy, bulky, power consuming focal plane electronics with a potentially large decrease in the weight and power consumption of electro-optical imaging spacecraft telescopes. It also enables simultaneous, direct processing of a light pattern or image

Although preferred embodiments of the invention in either of its two major facets thus provide very significant advances relative to the prior art, nevertheless for greatest enjoyment of the benefits of the invention it is preferably practiced in conjunction with certain other features or characteristics which enhance its benefits. For example, although the two aspects of the invention may in principle be practiced separately, it is preferred that both be used in mutual conjunction together.

Further it is preferred that the combination further include a sensing method, which includes the steps of: selecting one or more photoelectric dyes, ordering layers of a film includes the photoelectric dyes, coating a substrate with the film, configuring the substrate into an array, exposing the array to a light pattern, and detecting a resulting optical phase shift by the array. This method can further include further includes the step of optimizing the dye film for use with particular wavelengths of imaged light by choice of film properties including film thickness, film density, film cross-sectional area, ionizable electrons per molecule, spectral reflectivity and absorptivity, and angle of molecular orientation to the substrate.

In preferred embodiments, the method includes producing a light beam phase-shifted by the array, and transmitting the phase-shifted beam as a data link. In other preferred embodiments the method includes deriving the phase-shifted beam from interaction of a reading beam and the array directly with no intervening electronic stage. The reading beam can be a laser or light-emitting diode. In particularly preferred embodiments for use as an imaging method, additional steps include detecting the laser beam and applying the laser beam to reconstruct an image carried in the light pattern. The step of imposing a magnetic field on the array to interact with the array and produce the phase-shift is also included in preferred embodiments. Another step includes producing a magnetic field force on energetic electrons, wherein the force causes elliptical polarization of a light reflected from the reading beam. Additionally the reading beam is raster scanned. The scan rates of the scanning laser beam can be adjusted to aid image motion compensation and smear reduction. The intensity of the laser beam can also be modulated.

Furthermore, preferred embodiments include the steps of amplifying, expanding and collimating the phase-shifted beam. Additional preferred embodiments include the step of optically processing the phase-shifted beam. This processing step can include identifying particular objects. The objects can include man-made objects. Also, the resulting image light can be processed.

Particularly preferred embodiments include the steps of automatically monitoring resulting image light, wherein the monitoring can be annunciating the resulting optical phase shift, alerting an operator to the resulting optical phase shift, robotically carrying out an appropriate response to the resulting optical phase shift or automatically performing a task in response to the resulting optical phase shift.

The foregoing may be a description or definition of the third facet or aspect of the present invention in its broadest or most general terms. Even in such general or broad form, however, as can now be seen the first aspect of the invention resolves the previously outlined problems of the prior art.

Now turning to a fourth of the independent facets or aspects of the invention; the facet is a molecular sensing array preparation method, including the steps of selecting one or more photoelectric dyes, ordering layers of a film includes the photoelectric dyes, coating a substrate with the film, and configuring the substrate into an array.

In preferred embodiments of this fourth facet, includes the step of optimizing the dye film for use with particular wavelengths of imaged light by choice of film properties including film thickness, film density, film cross-sectional area, ionizable electrons per molecule, spectral reflectivity and absorptivity, and angle of molecular orientation to the substrate.

In another of the independent facets or aspects of the invention; a test method for testing an optical-phase shift based imaging system, the method includes the steps of exposing an optical phase-shift material to a light beam, locating the material in a rotating mechanism placed perpendicularly to the light, incrementally rotating the exposed material, exposing a polarizer to a resulting light beam and detecting the resulting light beam.

In preferred embodiments of this fifth aspect, a magnet is located in the rotating mechanism, and the optical phase-shift material is exposed to the magnet. The light beam is a light source selected from an incandescent light, a light-emitting diode or a laser.

Moreover, in preferred embodiments polarizer is an analyzing polarizer. In other preferred embodiments a polarizing filter is exposed to the light beam. In yet another particularly preferred embodiment, the light beam is exposed to a prism located on the material and perpendicularly to the beam.

All of the foregoing operational principles and advantages of the present invention will be more fully appreciated upon consideration of the following detailed description, with reference to the appended drawings, of which:

### BRIEF DESCRIPTION OF THE DRAWINGS

FIG. 1 is a schematic diagram of the Kerr effect on a molecular sensing array;

FIG. 2 is another schematic diagram of the Kerr effect on a molecular sensing array with a close-up of dye molecules within the array;

FIG. 3 is a schematic diagram of a molecular sensing array with a blow-up of the dye molecule structure;

FIG. 4 is a schematic diagram of a molecular sensing array with a blow-up of the probable dye molecule electron distribution;

FIG. 5 is a is a schematic diagram of a molecular sensing array highlighting a multispectral array;

FIG. 6 is a schematic diagram representing a molecular sensing array microparticle substrate;

FIG. 7 is a list of examples of dye types experimentally prepared and used for forming optical phase-shift molecules;

FIG. 8 is a schematic diagram representing formation of monolayer of protoporphyrin IX on thiolated substrates;

FIG. 9 is a graph of linear dichroism of monolayers of Iron protoporphyrin IX;

FIG. 10 is a schematic diagram representing a preferred embodiment of the invention as a receiverless imaging system;

FIG. 11 is a picture of optical arrangement for film characterization;

FIG. 12 is a schematic diagram representing film characterization optics to verify dye/substrate monolayer;

FIG. 13 is a picture of film characterization equipment, specifically a diode array spectrophotometer;

FIG. 14 is a schematic diagram representing a test method for characterizing monolayers that polarize light;

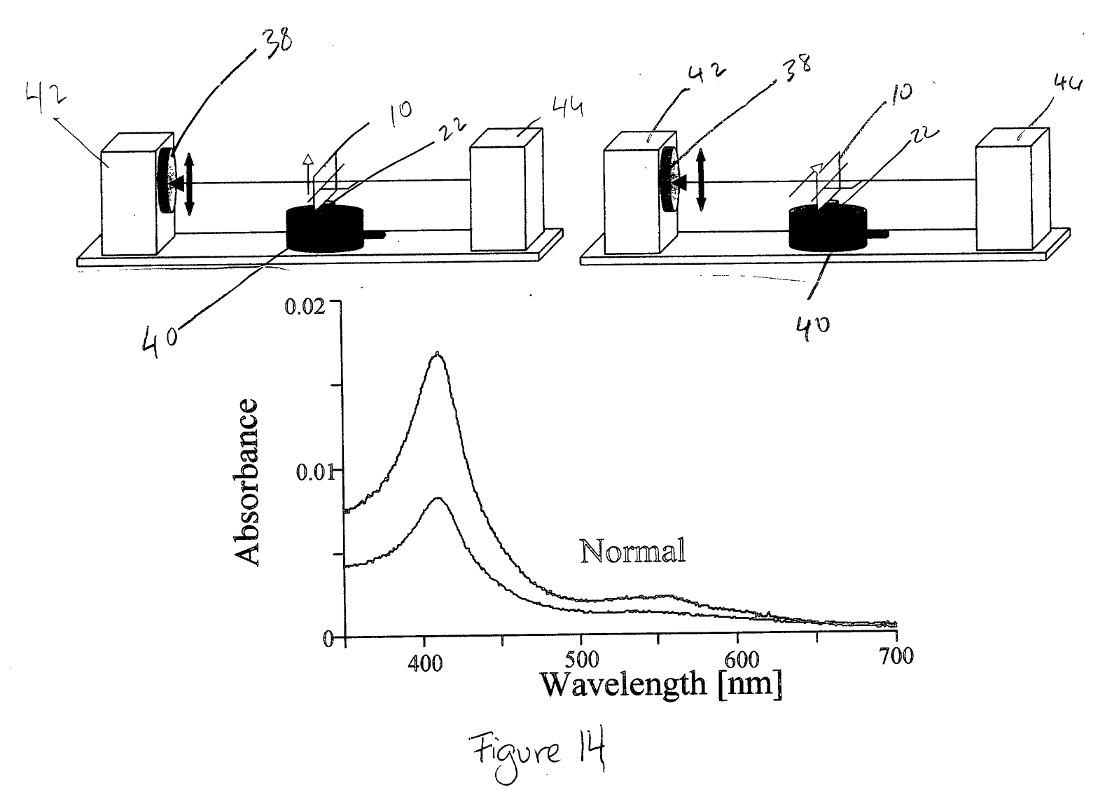

FIG. 15 is a picture of a preferred demonstration approach using a spectroscopic ellipsometer;

FIG. 16 is a schematic diagram and graphs representing an ellipsometer polarization change demonstration;

FIG. 17 is a schematic diagram representing a prism-based monolayer characterization method;

FIG. 18 is a schematic diagram representing a monolayer characterization method;

FIG. 19 is a schematic diagram representing a prism-based monolayer characterization method;

FIG. 20 is a block diagram representing preferred applications of the molecular sensing array;

FIG. 21 is a block diagram representing a preferred surveillance system of the invention;

FIG. 22 is a block diagram representing a preferred serial imaging system of the invention;

FIG. 23 is a block diagram representing preferred electronics-free applications of the invention;

FIG. 24 is a schematic diagram representing prior art CCD elements;

FIG. 25 is a graph displaying dynamic range comparisons among commonly known sensors; and

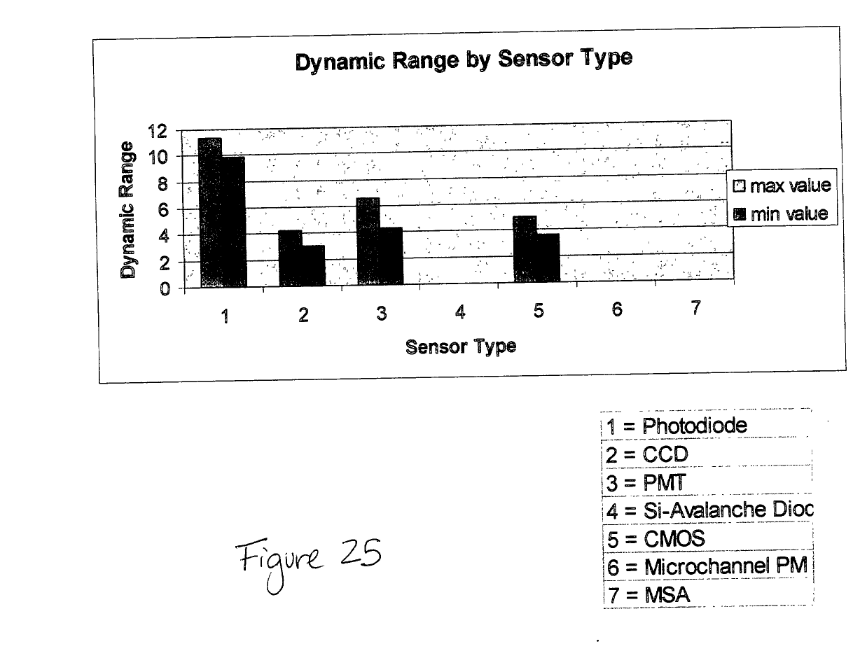

FIG. 26 is a table displaying parameter comparisons among commonly known sensors.

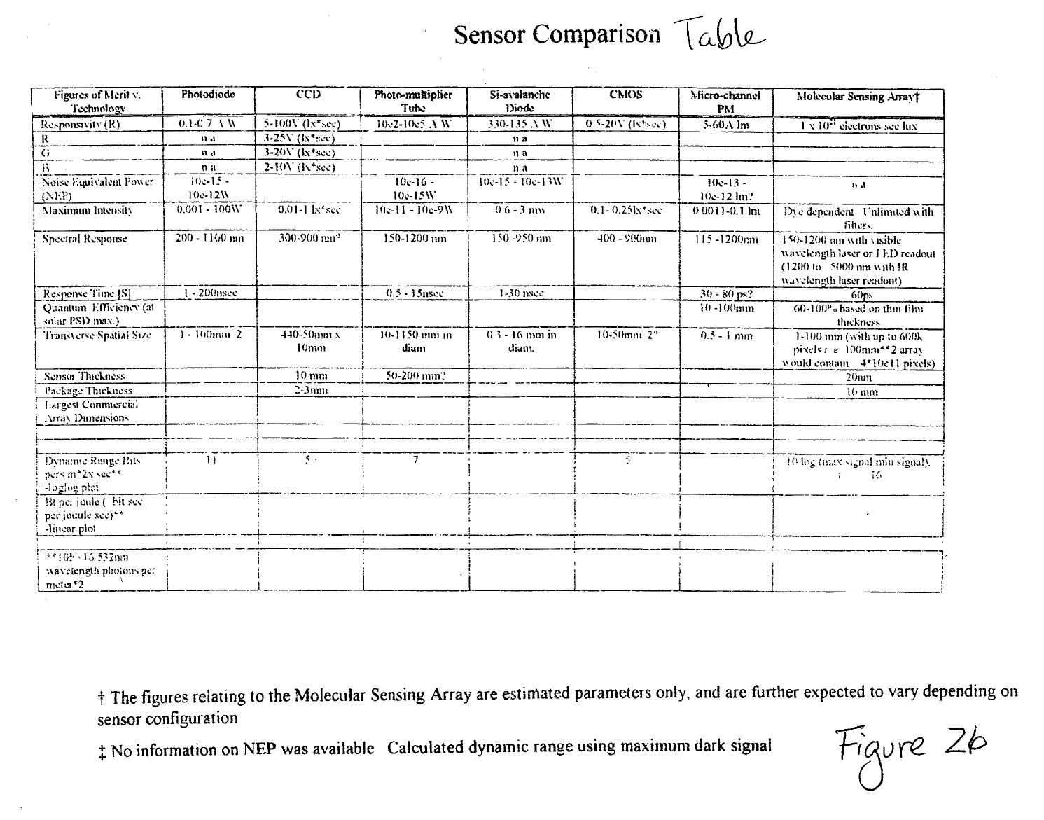

### DETAILED DESCRIPTION OF THE PREFERRED EMBODIMENTS

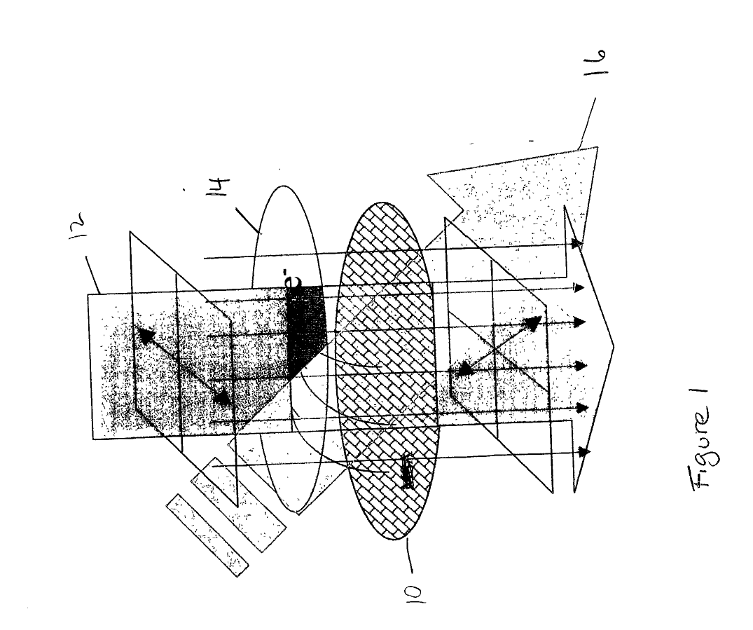

The present invention is based on an optical phase-shift material (OPSM) for use in a wide variety of sensing applications. As shown in FIG. 1, the optical-phase shifting material contains photon-energized electrons which interact with a magnetic field. Incident light of some frequency that comes into contact with the material, and is absorbed by photoelectrons moving to a higher energy state. Using a probe laser to scan the OPSM, results in an optical-phase shift of the beam. This phenomena is referred to as a Kerr or magnetooptical effect. The Kerr effect demonstrates that the manner in which light propagates through a material medium can be influenced by the application of an external magnetic field and is described in more detail to follow.

When a laser beam scans the OPSM, as depicted in FIG. 1, the beam becomes polarized in proportion to the population of excited photoelectrons in the material, due to the Kerr effect. A portion of an image can then be detected by analyzing the change of polarization of the laser probe at a particular position on the OPSM.

The Array

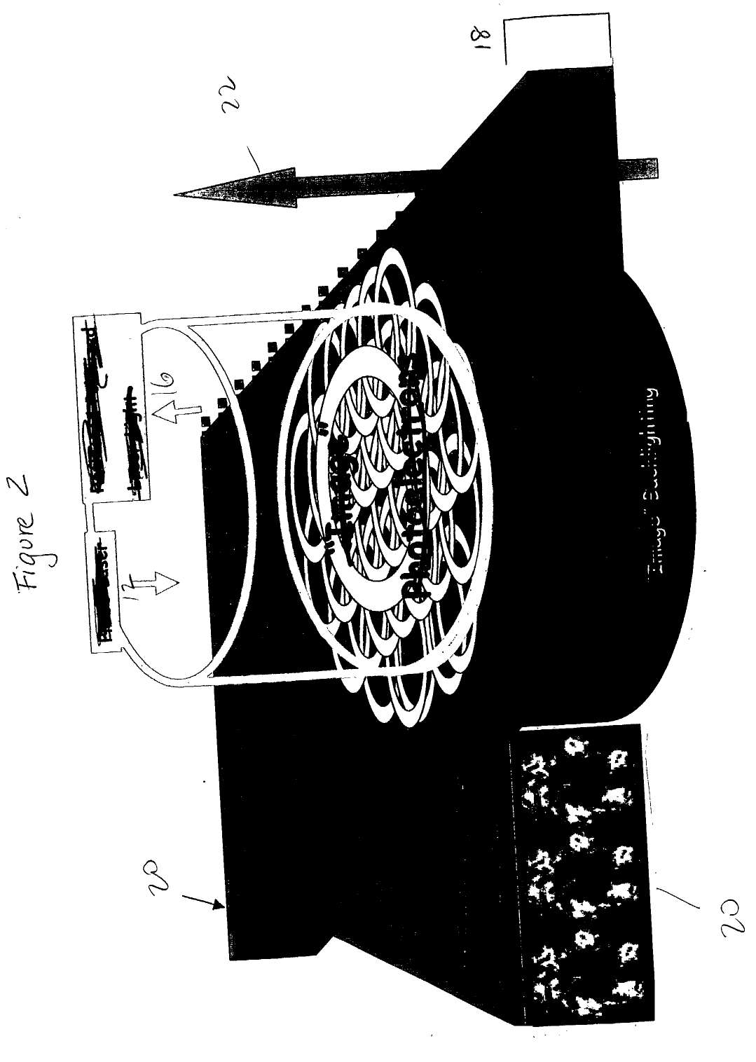

In many preferred embodiments of the invention, the OPSM is in the form of an array which comprises a substrate surface supporting a dye containing photoelectrons which interact with a magnetic field. In FIG. 2, located above an image is the OPSM array or molecular sensing array (MSA) 10 with a magnetic field extending perpendicularly to the array. The magnetic field is extending in the opposite direction of the probe laser beam. Looking at the figure in detail, the substrate is coated with a thin film of synthetic or organic dye molecules also seen in the blowup to the side of the figure. Toward the center of the figure, excited photoelectrons are circulating within the MSA 10 as polarized light is being reflected back away from the array.

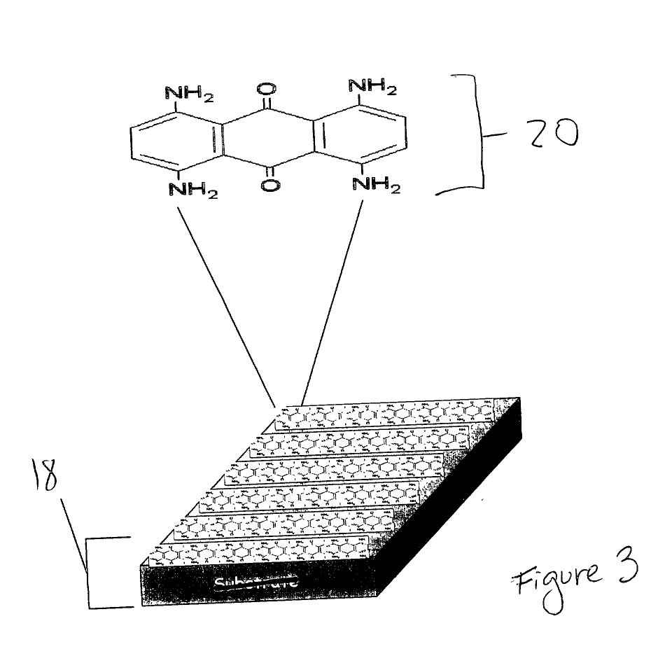

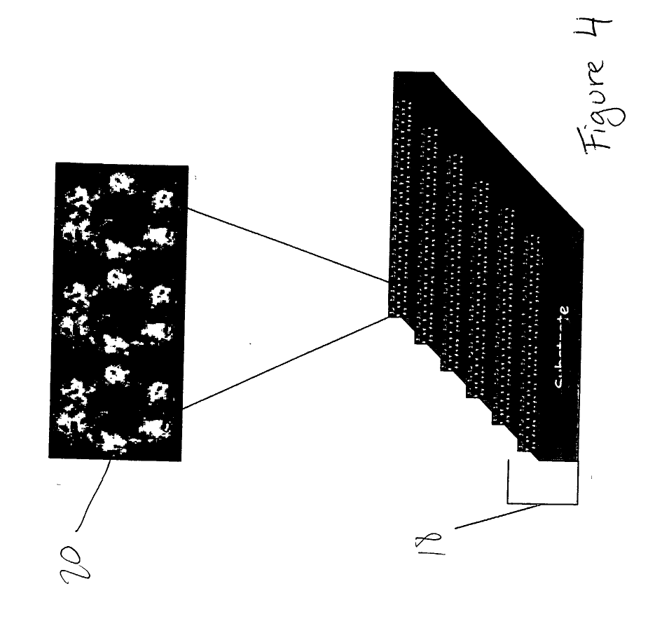

Basically, light cast from an image, onto the MSA, 10 is absorbed by the MSA 10 causing its photoelectrons to temporarily reach a higher energy state and in turn cause elliptical polarization and a phase-shift in a probe laser light source that is scanning the MSA 10. This laser light phase shift occurs as a result of illumination of photoelectrons within the MSA 10 that produce, in effect, an electron current of the image photons that is localized by an external magnetic field. In other words, the illuminated photo-electrons populate a “conduction band”. The electron motion is oriented by a static magnetic field and the conduction band or “ring electron current” phase shifts the probe laser beam. This can be seen in FIG. 3, which shows a preferred example of an MSA 10. In the figure, the substrate is coated with disperse blue as an example of a thin-film dye. FIG. 4 shows a closer look at the same MSA 10 with an enlarged view of the dye molecules. The dye molecule view shows an illustration of the probable electron distribution in the three benzene rings of the dye molecule.

The optical phase shifting dyes produce electron-hole pairs under the influence of near ultraviolet (UV) and visible image or pattern light. The free electrons in the dye molecules then interact with a static magnetic field to exhibit measurable changes in birefringence wherever an imaging photon strikes the array. The image photons induce the dye molecule electrons or photoelectrons to transition to a higher energy state such as from an s-orbital to a p-orbital shell with enough of a change in the anisotropic dielectric constant, which is responsible for elliptically polarizing the incident imaging light, to support application of the MSA 10 for imaging in longer wavelengths such as in the mid-infrared range. Readout of the image is still accomplished by a scanning probe light beam, but may require longer wavelength (exceeding the image light wavelength) to avoid producing the same effects as the imaging light.

The change in electron energy states only occurs where incoming image photons or light patterns contact the array and induce the change. The OPSM can be imagined to act as a photographic film that only stores an image for tens of microseconds. During the storage time, the scanning or readout probe light scans areas of the OPSM array that is selected or desired to be read.

Thus, whenever an incoming image photon creates a photoelectron or transfers an electron to a different orbital (higher energy) state, the photon changes the “appearance” of the array as it is scanned by the laser. The scanning or readout probe laser is then reflected with changing degrees of elliptical polarization directly depending on the changed state covalent-bond electrons which in turn depends on image photon flux. The addition of a static magnetic field perpendicular to the array plane still provides for local changes in magnetooptical force to produce anisotropic birefringence wherever the image or light pattern photons strike the MSA 10.

The absorption of an image photon transitions a dye molecule electron into a higher energy state in tens of picoseconds. The new state persists for tens of microseconds until relaxation reduces the photon excited electrons back to their original state. Similarly, the energized photoelectrons will persist as free electrons until their mobility results in combining with a place in the same or adjacent dye molecules after the photoelectron loses sufficient energy and returns to a state of relaxation. The creation and extinction time of the measurable, short-lived energetic states are the same; approximately 60 to 100 picoseconds for creation and tens of microseconds for relaxation and extinction.

The dye molecules function similarly to pixels and can be likened to “virtual pixels” since they are the smallest distinguishable and resolvable area on the portion of an MSA 10 that is projecting image light. Also, in continuing the analogy, the OPSM array is placed at the equivalent of a focal plane, more accurately referred to as a focal surface in this example. Accordingly, the focal surface of the array has an f/number roughly approaching one or smaller. The OPSM arrays, moreover, will eliminate shift register electronic pixel readout. In fact, it will not be possible to electronically readout OPSM pixels. Thus, use of focal plane electronics will be limited, e.g. to controlling the readout laser.

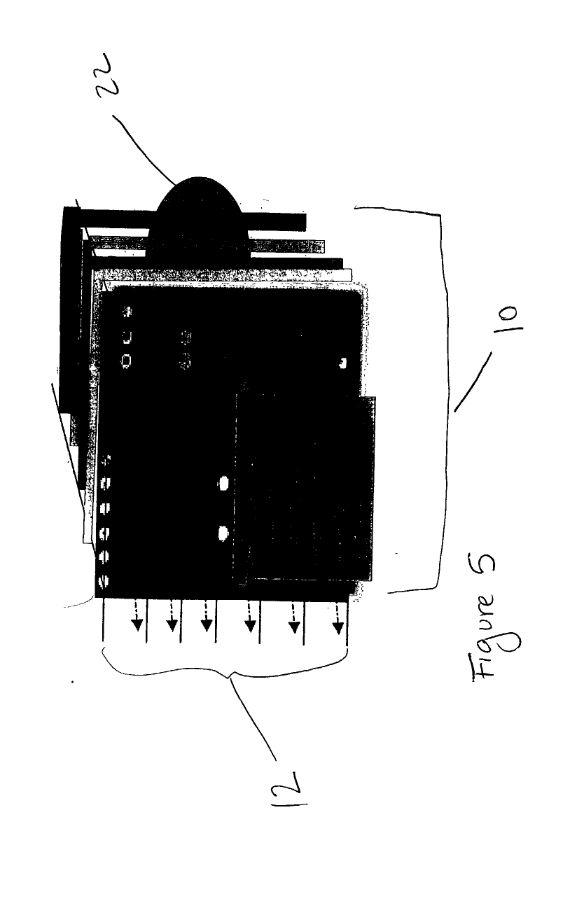

The interaction of the MSA 10 and the magnetic field perpendicular to it, is again shown in FIG. 5 which illustrates an image generating image photons that are sandwiched between a static magnetic field in the form of a ring-shaped permanent magnet with B field normal to the MSA array, in order to produce a Kerr effect, and the MSA itself. The MSA can then be raster scanned to obtain a readout of the image.

It is important to measure the image photon induced energized photoelectron state rapidly. A portion of the readout laser light can serve this task while providing a raster scan to readout the array. This laser light must remain on long enough to measure adequate imaging photons, but then must in effect be switched off (like closing a camera shutter) or scan to other locations to allow the electrons to recombine with the donor dye molecules or revert to their prior energy state after an image has been integrated and readout. The laser is then pulsed for the next frame.

Subjecting the OPSM array to a constant magnetic field will orient the Kerr effect force term, making the axis along which the polarization and phase shift occurs, predictable. Thus, in a preferred embodiment, it is feasible to eliminate the raster scan readout by mixing the array readout with a reference beam from the same laser to produce a peculiar interference pattern as a data link that can be transformed for direct transmission to a relay or ground station. This requires analyzing how the peculiar diffraction pattern from an array of OPSM pixles is modified by unique localized phase shifts of the individual dye molecules (pixels).

The MSA can be prepared in many different forms for a wide variety of applications. For instance, the dye can be coated as a thin film on both planar and nonplanar substrates. In FIG. 5, multiple layers of dyes, each sensitive to a different wavelength are coated on the array. Specifically, the three film layers are in blue, green and red and are coated one on the next to produce a broad band visible light sensor. The multiple layers are used to optimize sensitivity of the array by combining dyes sensitive to the differing wavelengths of light. In the figure each dye layer is shown in a separate plane for illustration purposes. Across the face of the array are horizontal arrows showing the direction of scanning by the readout laser probe.

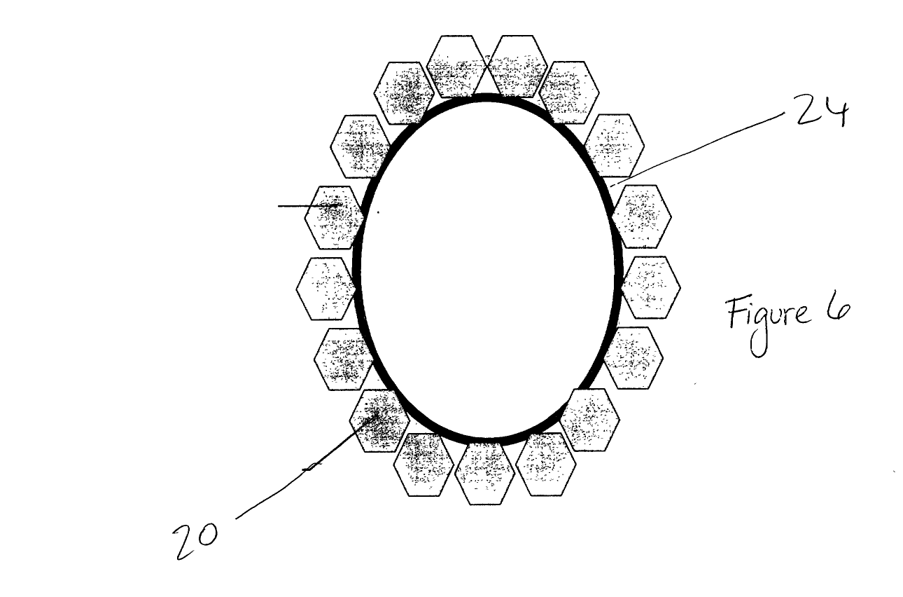

In FIG. 6, an example is shown where the dye in the form of a thin photosensitive film is coated on microscopic particles, more particularly microspheres on the order of 50 to 500 nanometers in diameter (about 20 to 200 times smaller than a 10 micron CCD pixel and is equal to or smaller than a wavelength of light). The figure shows a schematic of one dye coated macromolecule or microsphere, where the dye is the source of photoelectrons. Many of these microspheres can be self-assembling or arranged together to form a substantially seamless array due to their extremely small size. In preferred embodiments of the microsphere or microparticle substrates, the substrate is made of a dielectric material in the form of self-assembling microparticles. The dye molecules are electrically polarized and as a result readily attach to the dielectric material and to one another. For example, experiments show that placing a slide in a beaker containing the molecules results in the formation of a coating upon the slide and analysis under a spectrophotometer shows the molecules acting as a polarizer, indicating regular, parallel alignment of molecules solely as a result of polarization of the molecules. Due the small size and regular alignment of these molecules, it becomes possible to arrange them in a substantially seamless array for the molecular sensing system of the invention.

Moreover, because the dyes can be coated on both planar or nonplanar substrates, the dye can be coated on inverted microparticles as in dye microdroplets where the substrate surface surrounds the dye or the dye can be coated on cavities formed within a substrate. Such substrate particles can exist in many shapes and can even form as particles of dye trapped in empty vacuoles that form within the polymer substrate material as it is cured and dried. There is no limit to the shapes of the array since the nonplanar substrates include curved hemispherical and even cylindrical substrates.

The Dye

The MSA can be made from most any good conductor for nanoparticles e.g. gold or silver as long as it has the ability to react to incoherent image photons by producing ring electron current that phase shifts laser readout. In preferred embodiments, gold or silver nanoparticles are used in the dye or substrate material because of wide-band synchronization for electron charges and therefore the Kerr effect is enhanced. Other examples of nanoparticles selected for increased sensitivity and photoelectron control include mesoporous TiO₂ (100-250 anstroms), fumed silica, polystyrene and fullerene. Preferred polymers for physical structure on the support substrate include epoxy glues as were used in experimental trials, polystyrenes, polyethylene glycol (PEG), and polyvinyl alcohol. While, Kerr originally used polished metallic surfaces in his original experiments proving polished metal to be an acceptable substrate material, using glass or quartz has the advantage of greater than ninety percent transmission from 300 nanometers to 2.5 micrometers to make sensor image front or backlighting possible.

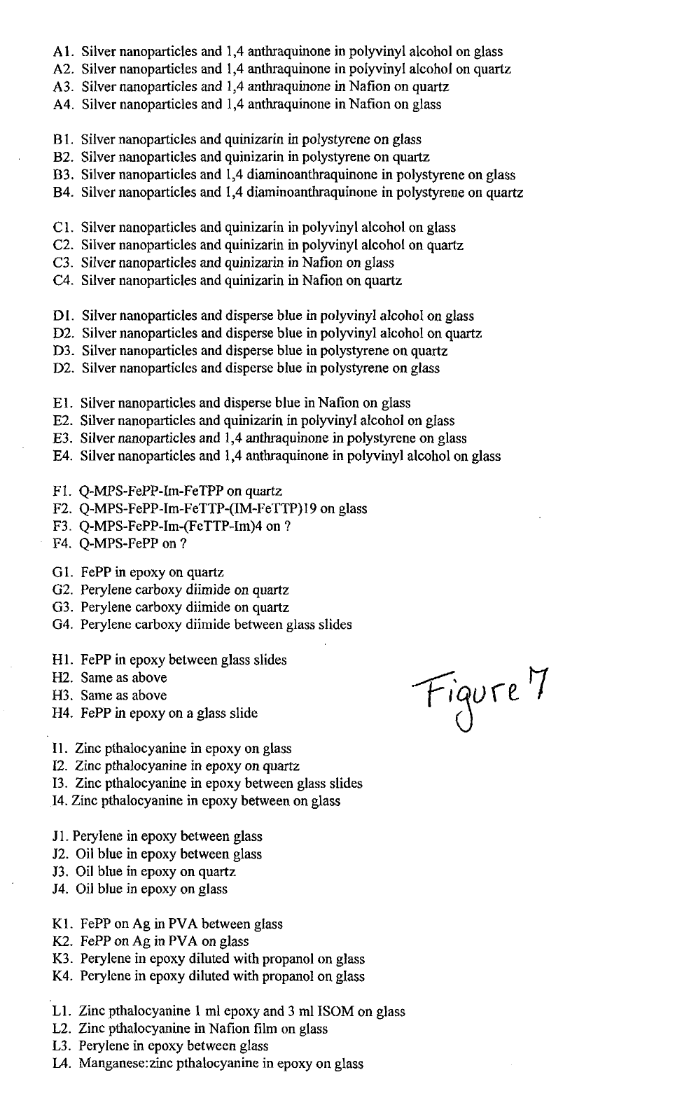

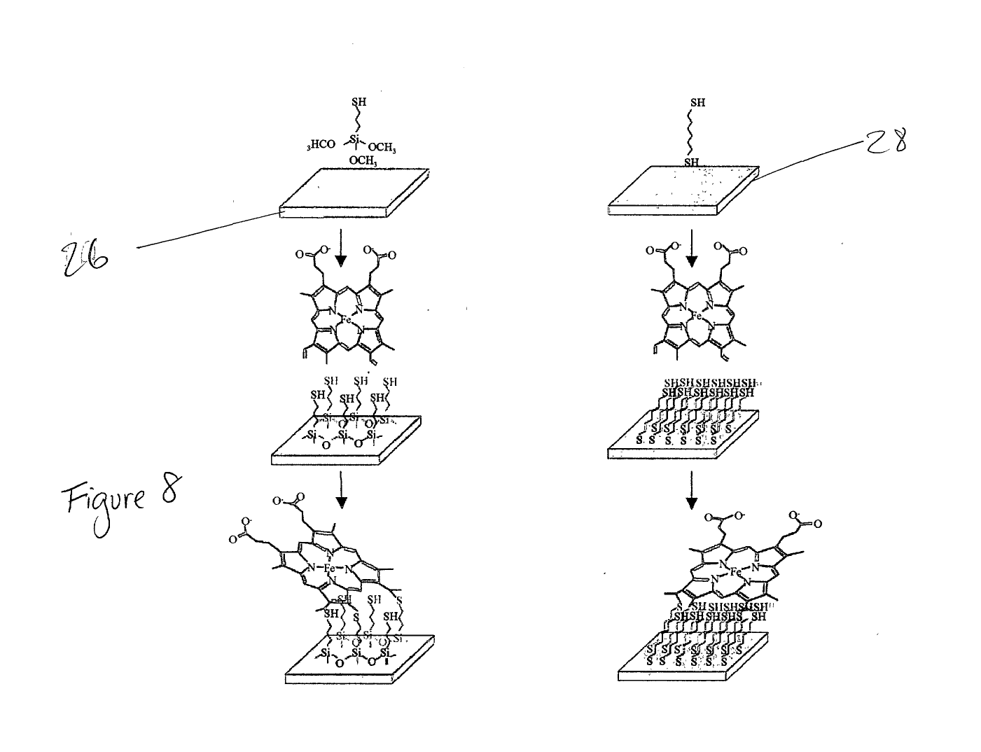

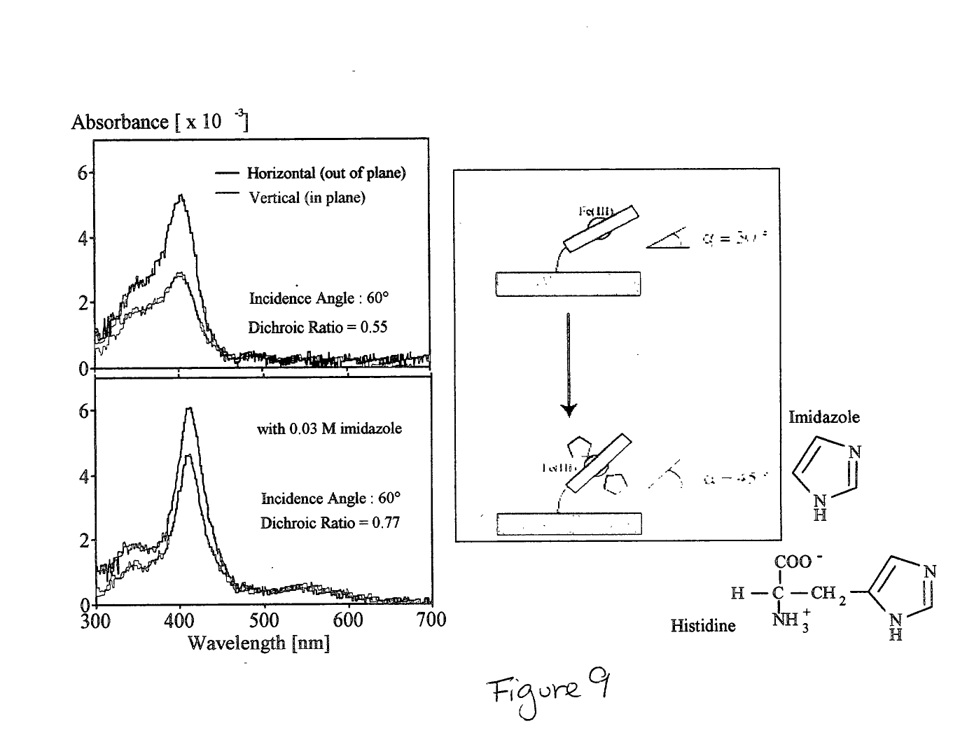

Other preferred embodiments use ferromagnetic ions like iron porphyrin in the dye polymer. These dye molecules are photoionizable molecules that are similar to the silver based chemistry systems used for film. The dye types can be combined to increase sensitivity to longer wavelengths. FIG. 7 shows a list of examples of dye types experimentally prepared and used for forming OPSMs. This list includes anthraquinone or phthalocyanine dye in polymer film, porphyrin or phtalocyanine multimonolayers on silanized quartz, microencapsulated anthraquinone or pthalocyanine with liquid crystal in polymer, silver nanoparticles coated with anthraquinone or porphyrin dye, silver nanoparticles in charge transfer complexes using C60 (carbon “buckyballs”). FIG. 8 shows the formation of a monolayer of protoporphyrin IX on thiolated substrates of quartz and of gold. The first step shown is the pretreatment of the substrate by thiolation. This step is followed by attachment of the protoporphyrin by thioether linkage formation. FIG. 9 shows linear dichroism of monolayers of iron protoporphyrin IX as a reference.

Kerr Magnetooptic Effect

In 1845, Michael Faraday discovered that the manner in 11 which light propagated through a material medium could be influenced by the application of an external magnetic field. In particular, he found that the plane of vibration of linear light incident on a piece of glass rotated when a strong magnetic field was applied in the propagation direction. The Faraday or magnetooptic effect was one of the earliest indications of the interrelationship between electromagnetism and light. The angle β through which the plane of vibration rotates is given by the empirically determined expression β=VBd, where B is the static magnetic flux density, d is the length of the medium traversed, V is a factor of proportionality known as the Verdet constant which varies both with frequency and temperature and is empirically determined.

A similar mangetooptical effect was discovered approximately thirty-five years later by Kerr when he noticed a change in polarization of light that reflected from a polished metallic surface of an electromagnet.

An essential element to the application of our approach is a basic understanding of the Kerr Effect as it is described below. The Kerr Effect occurs when the dye is present in a magnetic field. This effect, also referred to as a magnetooptical effect is based on F=qE+qvxB; where the qvxB term generates a polarization and phase change.

In this case, circularly polarized radiation traveling in the direction of the magnetic field induces a different polarization depending on whether the polarization is left handed or right handed. This has the effect that linearly polarized light reflected off the dye surface will become elliptically polarized with a shifted polarization axis. Thus by reflecting light off the dye and detecting changes in polarization one can measure the number of electrons that were excited in the dye, and hence the amount of light incident on the dye. Similarly, if the MSA material is transparent to the readout laser, one can also transmit the laser through the material and observe the change in polarization of the transmitted beam to measure the amount of ionization that occurred.

The signal to noise ratio, however, must be-sufficient to recognize the image photon induced effect. Noise is the background magnetooptical effect caused by polarizing interaction of the readout energy field and the constituent molecular sensing array molecules.

Molecular Sensing Array System

The sensing system of the invention includes an optical phase-shift material (OPSM) in the form of an array, means for exposing the optical phase-shift material to a light pattern or image and means for detecting a resulting optical-phase shift by the material.

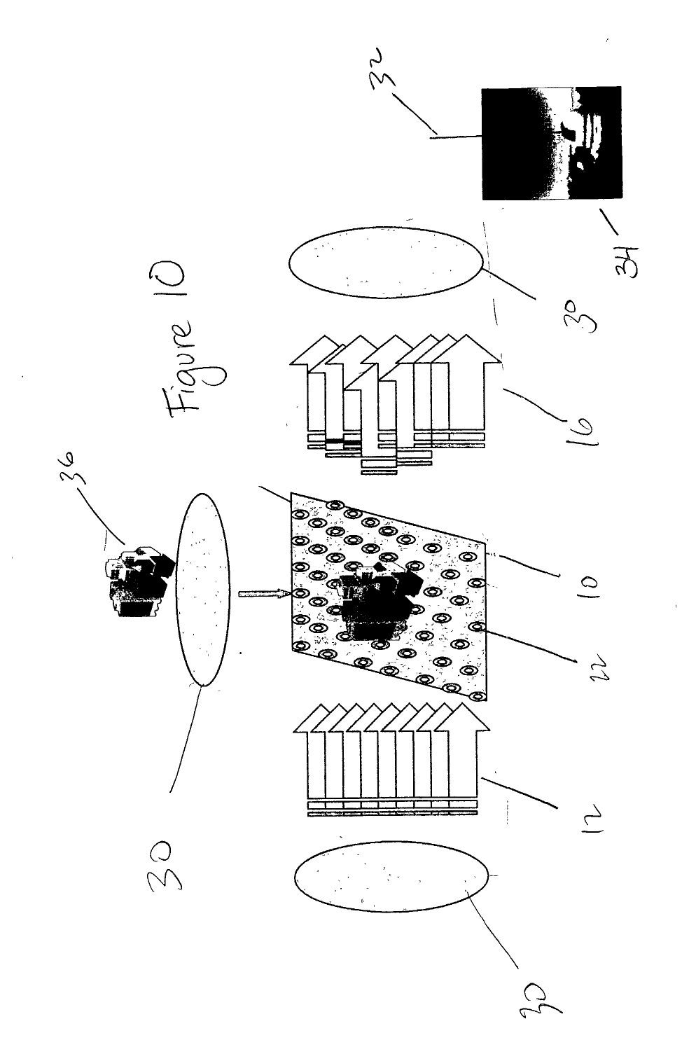

FIG. 10 is a schematic diagram depicting the OPSM in the form of an array in a preferred example of a 50K×50K array in 2 centimeter by 2 centimeter size, with a layer of magnets creating a magnetic B field perpendicular to the plane of the array. Means for directing a readout such as a raster or probe laser scan through the array and can be used with means for focusing the beam such as optics. The scanning of the array surface can be limited to desired portions of the array or can be of the entire array, depending on the application. The scanning laser beam readout, however, should count the energized photoelectrons as a function of their X and Y positions on the array at the time of scanning. Means for focusing an image onto the molecular sensing array such as telescope or microscope optics can also be used. The resulting light from the beam that passes through the array is phase shifted and its resulting light or image light pattern becomes the data link transmitting the phase-shifted beam. Means for focusing the image such as telescope optics can again be used to transform the laser to a downlink or parallel optical processing station such as a telescope on a station. The station can be located on Earth or any planetary station or can be located on a near-planetary vehicle to receive the data link from a space-based module.

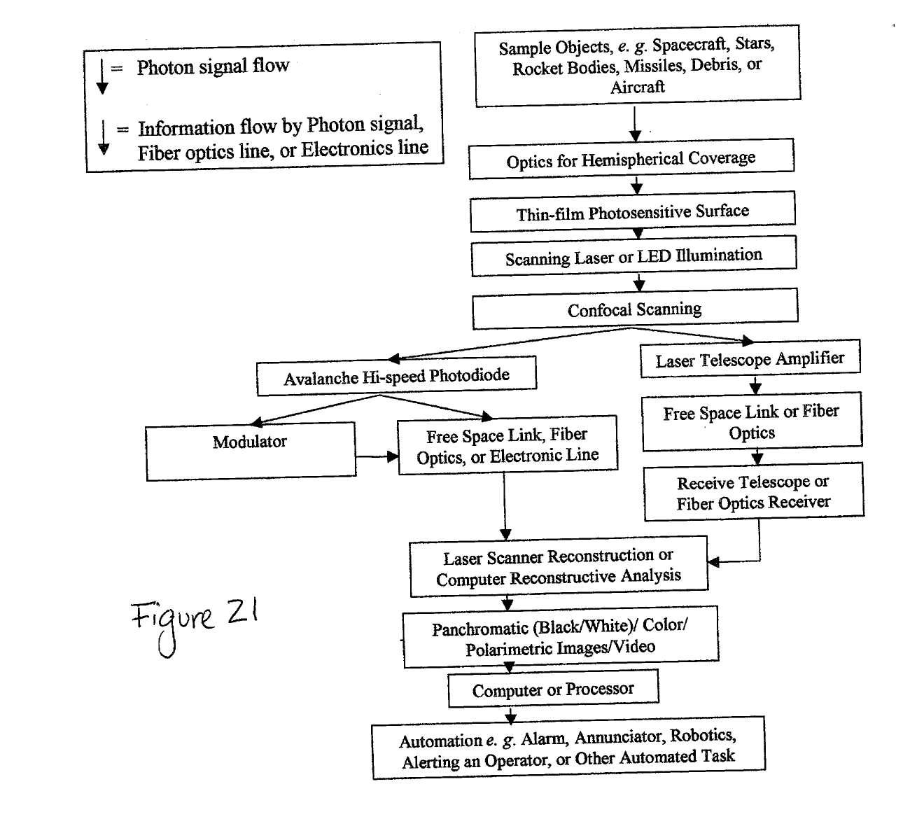

Once the data link is detected by a downlink telescope or photodiode detector as depicted in the block diagram of FIG. 21, the signal can be amplified, expanded and collimated using a telescope or other optical processing means as shown in the figure. Optical processing of the phase-shifted beam can include laser scanner reconstruction or computer reconstructive analysis of the image. This data can then be processed for presentation purposes, for example annotations or other markings can be overlaid on the resulting image light. The resulting image can be displayed as panchromatic, black, white, color or polarimetric images or as video. The images can also be electronically or optically processed using a computer or processor to analyze the resulting image for motion detection, trajectory, color polarization detection, identification of particular objects e.g. man-made objects, or surveillance.

As depicted in FIG. 21, automatic means for monitoring the resulting image can also be readily implemented to alert an operator or another system; or to carry out an appropriate response to the resulting image. In preferred embodiments, these automatic means include an annunciator or alarm for alerting an operator or system, robotics for carrying out an appropriate response to the resulting image, or an automated task performed in response to the image.

Sensing Method

The molecular sensing array (MSA) includes one or more dye layers that absorb incident light of some frequency, creating photoelectrons which generate a Kerr or magnetooptical effect. In preferred embodiments, the Kerr effect is then read by a readout laser of a different frequency.

Looking at the generation of the photoelectrons by the incident light, we begin with customizing the optical phase-shift material and its array. Parameters to consider include the distribution of a dye layer, its thickness, cross sectional area and density. In optimizing the appropriate dye polymer material, it is important to select a dye with sensitivity, in other words, absorption strength at the wavelength of the incident light and selecting one that can ionize some maximum number of electrons per dye molecule. In experimenting, it is assumed that the ionized electrons are confined to the thickness and cross-sectional area of the dye element.

A readout laser is selected based on adequate interaction with the free electrons donated by the imaging photon activated dye molecules. The readout laser must produce an adequate phase shift or polarization change to provide adequate signal to authentically represent the distribution of image photons over the MSA. This can be calculated based on the readout frequency, area, waveform, flux and coherency.

Once optimal conditions and parameters have been selected for the OPSM including the dye layers and their polymer substrate as well as for the readout laser characteristics, preparation of the array can proceed.

Preparation of the dye film is non-toxic and doesn't even require use of a vented hood. In a preferred example, quartz or glass precision microscope slides are used as a substrate and are cleaned thoroughly to remove contaminants even from within microcracks in the glass. The dye polymer is coated on the substrate as a photosensitive thin film. Coating mechanisms for thin films are commonly known in the art. The simplicity of the dye coating process using dye film surface tension or spin coating allows the arrays to be mass produced with high production yields and relatively low costs, especially in comparison to current semiconductor manufacturing processes. The coating process results in dye molecules that are attached in a manner in which they are aligned in parallel and should be optimized to act dichroically. Methods on aligning polymers to polarize light are also commonly known in the art. The layers of dye molecules orient and electrostatically localize themselves in a reproducible array without the use of semiconductor photolithographic masks and toxic gases.

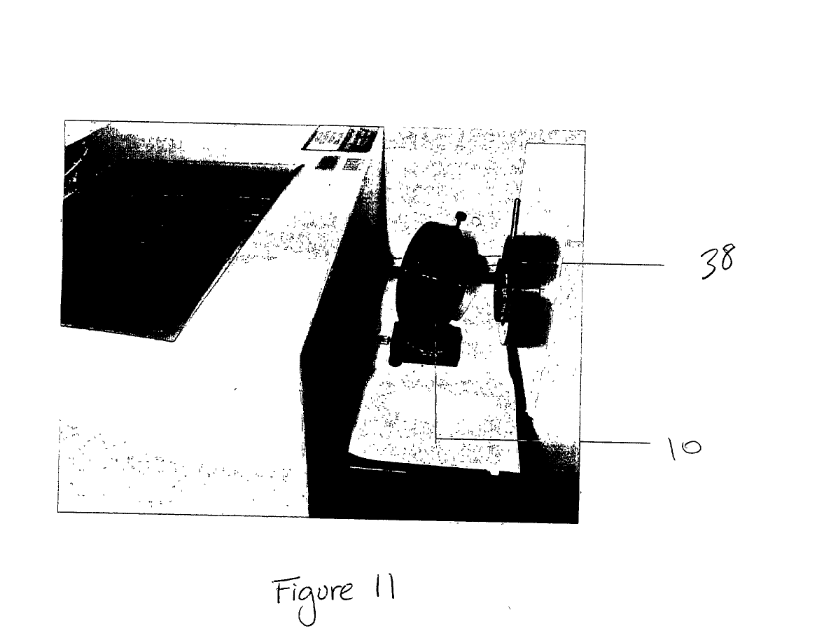

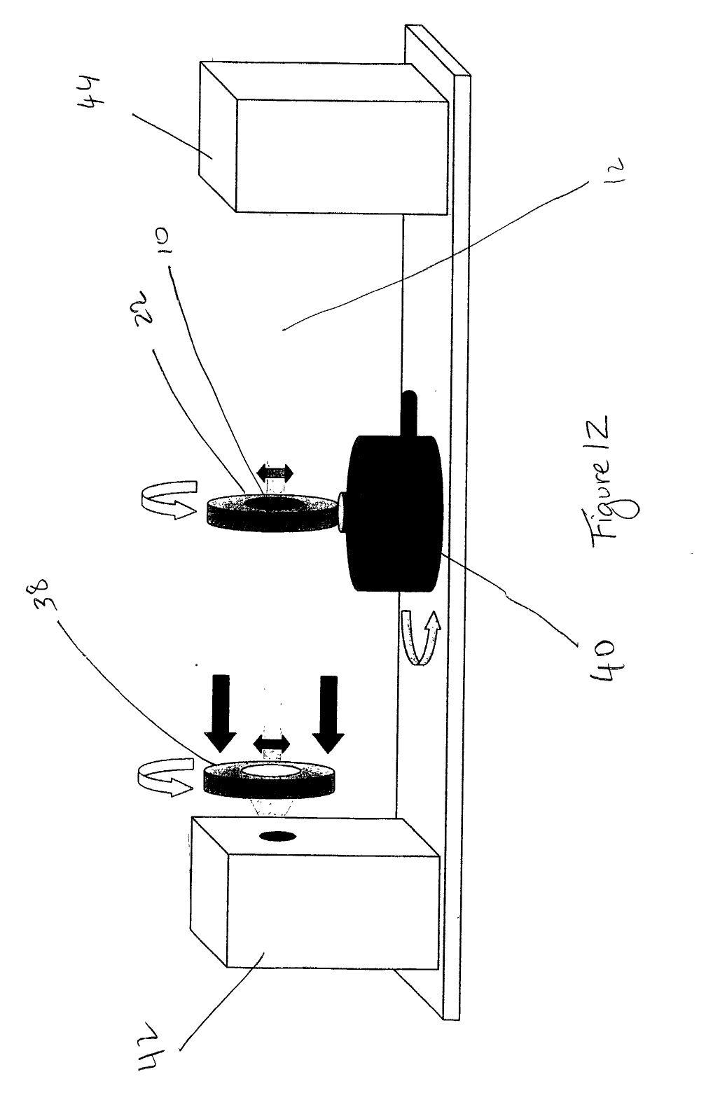

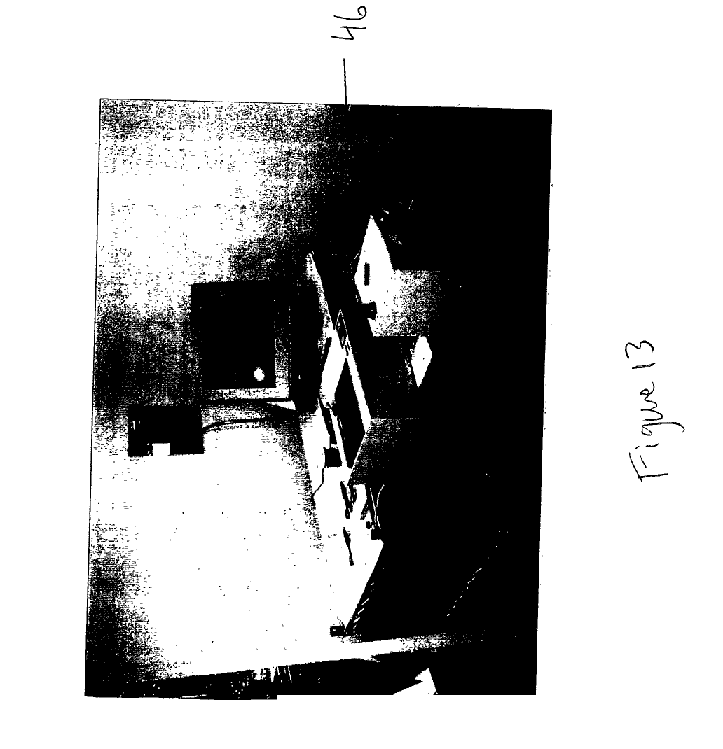

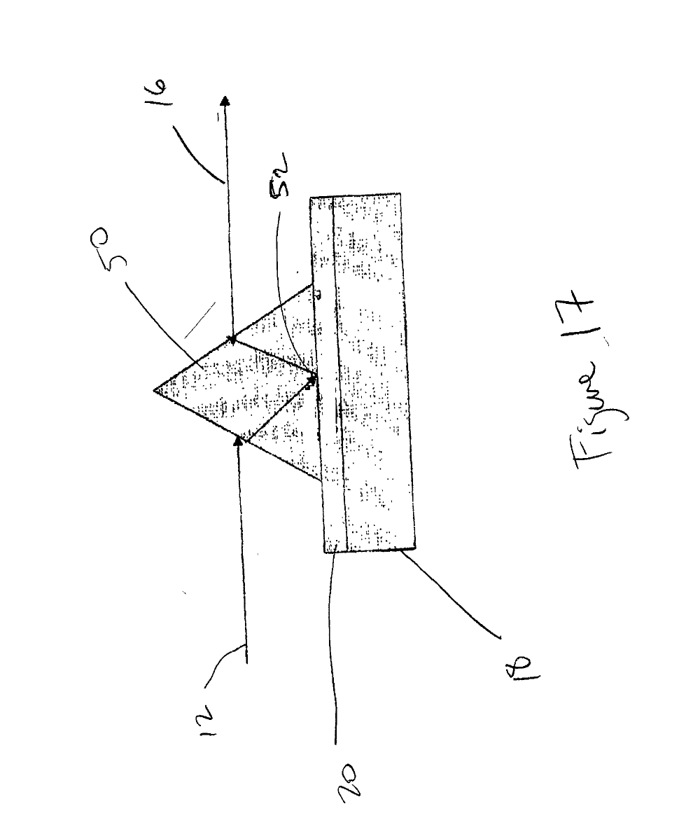

In this example, the substrate is transparent to visible light that backlights the dye/polymer film. The optical arrangement for film characterization can be analyzed using a mounted polarizer that can be rotated 360 degrees as shown in FIG. 11. The figure shows a photo of a mounted polarizer with a sample holder containing two rotational axis (both vertical and horizontal). Once a trial coating is completed, the substrate can be mounted on the rotating sample holder so the spectrophotometer broadband light passes through the sample on the way to the spectrophotometer grating and photodiode array. This allows testing to determine if the material has sufficiently cured and whether the dye-polymer molecules are sufficiently aligned for polarization. Using this instrumentation, the material samples can also be tested to measure refractive index and dichroism by rotating the sample in the sample plane where the dye molecules are “tilted” and a commercial polarizing filter can be attached to the rotator. A schematic diagram of this setup is depicted in FIG. 12. In the figure, a light source is shown with a light beam emanating to a sample with a rotating mount in which ring-shaped magnets can be place and a rotating plate. The beam then extends through a linear polarizer with a rotating mount before reaching a detector. For measuring polarization, the sample plane is rotated parallel to the polarizer plane as shown in FIG. 12 and the sample is rotated incrementally between spectrophotometer measurements. FIG. 13 shows a picture of an HP 8453 spectrophotometer with a ultraviolet/visible light diode array spanning 190 to 1100 nanometers used in these experiments as an example of a spectrophotometer. Other similar types of spectrophotometers may be used for testing purposes. Commercially made spectroscopic ellipsometers can also be used to determine the index of refraction of a material such as the dye coating of the OPSM by observing a change in polariztion and phase shift using a single measurement. This technique involves use of light through a prism as depicted in FIG. 17. In this setup, laser light simulates a readout laser with the angle varied to change theta at the prism and OPSM film interface where the near theta or critical angle is for internal reflection. The laser light interacts with the OPSM surface and the output amplitude varies as the OPSM is illuminated by simulated image light since the image light changes the index of refraction. The prism supplies index of refraction information without having to estimate the thickness of the substrate and without expensive equipment such as an ellipsometer, but does require rotation of the sample at a 90 degree angle for each measurement.

Other tests known in the art can be performed to measure elliptical polarization, as described by J. Jackson, “Classical Electrodynamics Calculation of Probe Photon and Dye Photoelecton Kerr Effect Change in Elliptical Polarization”. fully incorporated by reference herein. These tests can be performed and calculated by persons skilled in the art. They include multiple wavelength probing in the 200 to 1100 namometer range with combination of normal magnetic and no magnetic field, multiple wavelength (front or back) illumination or image photon stimulation and no illumination, with larger light angles, or light that is photon starved, moderate or at a bleaching intensity.

Once the system parameters are optimized, a small scale test can be implemented without the use of a raster scan, thus the test involves no moving mechanical parts or rotating mirrors. Basically the dye material is coated onto greater than one million lines per meter diffration grating. A high refractive index optical wedge is installed with a thickness gradient aligned with the grating lines. The entire wedge surface is then repetitively flash read and collimated with light-emitting diode (LED) red, green, blue (R,G,B) lighting. This “swept” light output is then focused into an erbium-doped fiber optic amplifier (ERDFA) telecommunications laser amplifier to produce a serial degree of polarization output. A person skilled in the art would understand these production steps based on the description as they are commonly recognized in the field. This setup allows a small scale and simple test method for the MSA without the use of a raster scan and rotating mirrors. The grating is used to replace the need for raster scanning. The optical wedge provides differing amounts of delay i.e. simulates sweeping of a beam. This allows calculation of the amount of delay introduced at one edge of the wedge based on its thickness. In order to determine where the dye is located, it is preferred that only one side of the substrate is coated with the dye. This essentially allows calibration of the wedge by correlating the resulting bands to the dimensions of the wedge area that is coated with the OPSM dye material.

Another simple experimental test can be performed to determine the sufficiency of the laser readout signal. The laser readout beam can be split-off and combined with a laser light illuminating a layer of OPSMs subjected to an on/off beam of visible light representing imaging photons. A sufficient laser readout signal should produce polarization and phase shifts.

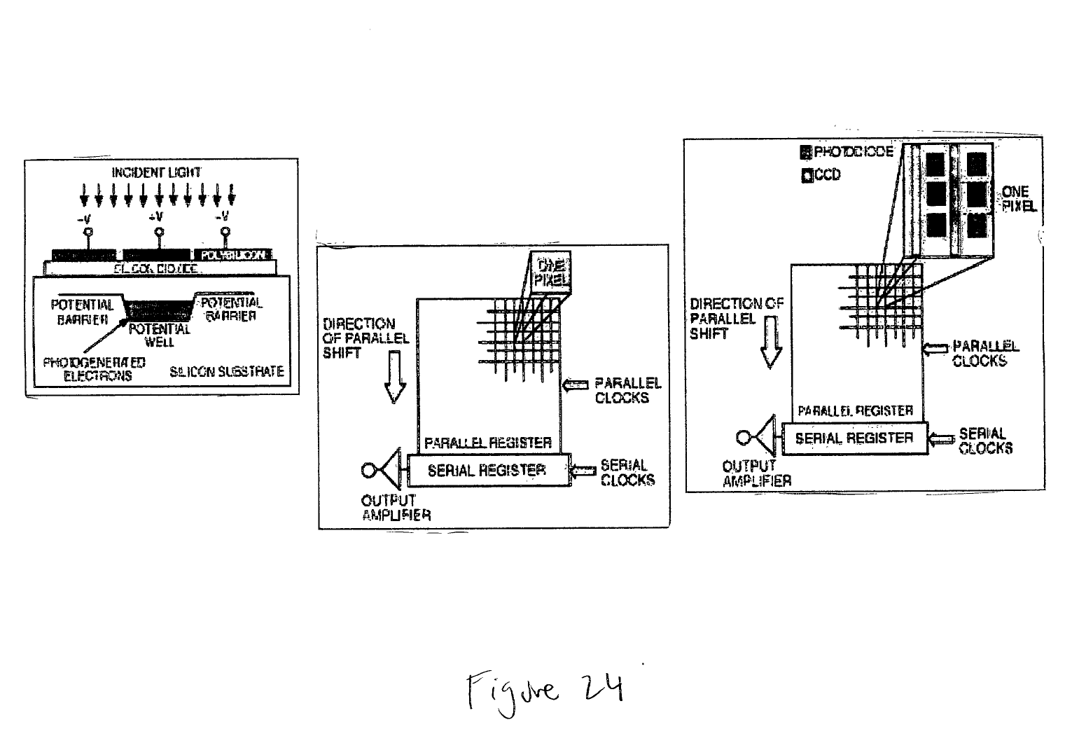

FIG. 24 a setup used to test a handmade sample of OPSM material made of FePP on a quartz slide. The orientation of the quartz slide and speed of withdrawal from the initial dye and epoxy solution cause significant alignment of the dye-polymer film molecules resulting in a favored direction of polarization. The sample had a direction of withdrawal from the imidazole solution parallel and normal to the direction of polarization of the polarizer. The goal in preparing this sample was to achieve a thin, uniform coating demonstrating alignment of most of the OPSM molecules verified by a simple spectrophotometer measurement. The OPSM molecules exhibited a significant degree of physical alignment in parallel. Thus, the resulting light absorbance behavior demonstrated that the sample monolayers polarized light. The sample demonstrated a 3:1 ratio of absorbance accompanying a 90 degree rotation of the sample.

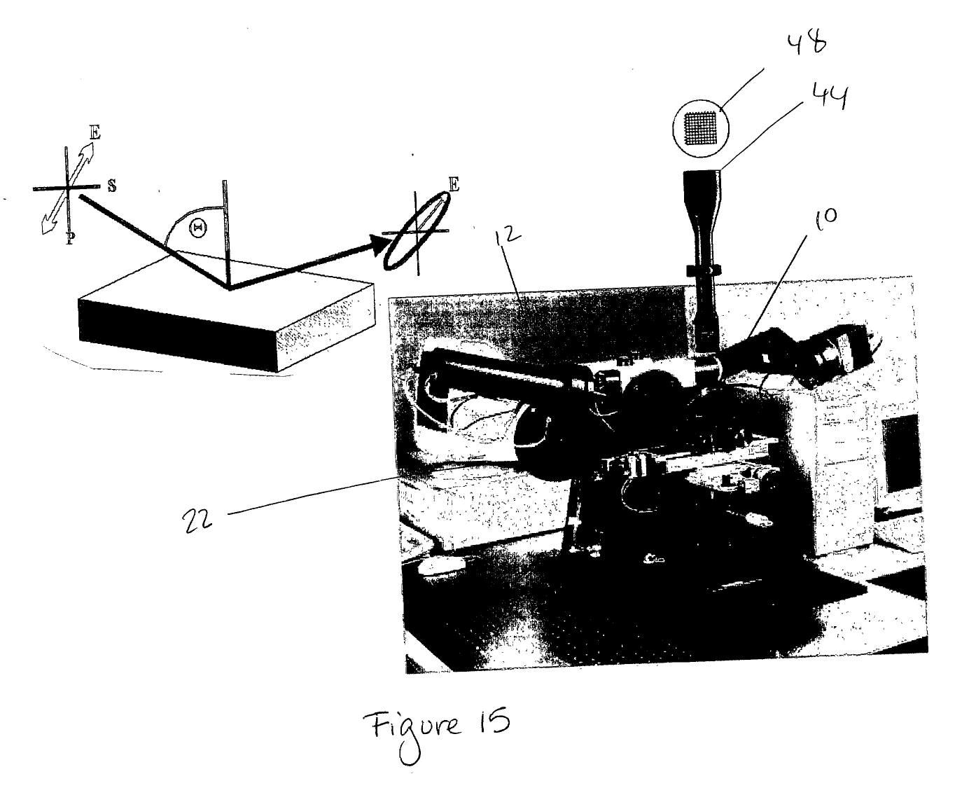

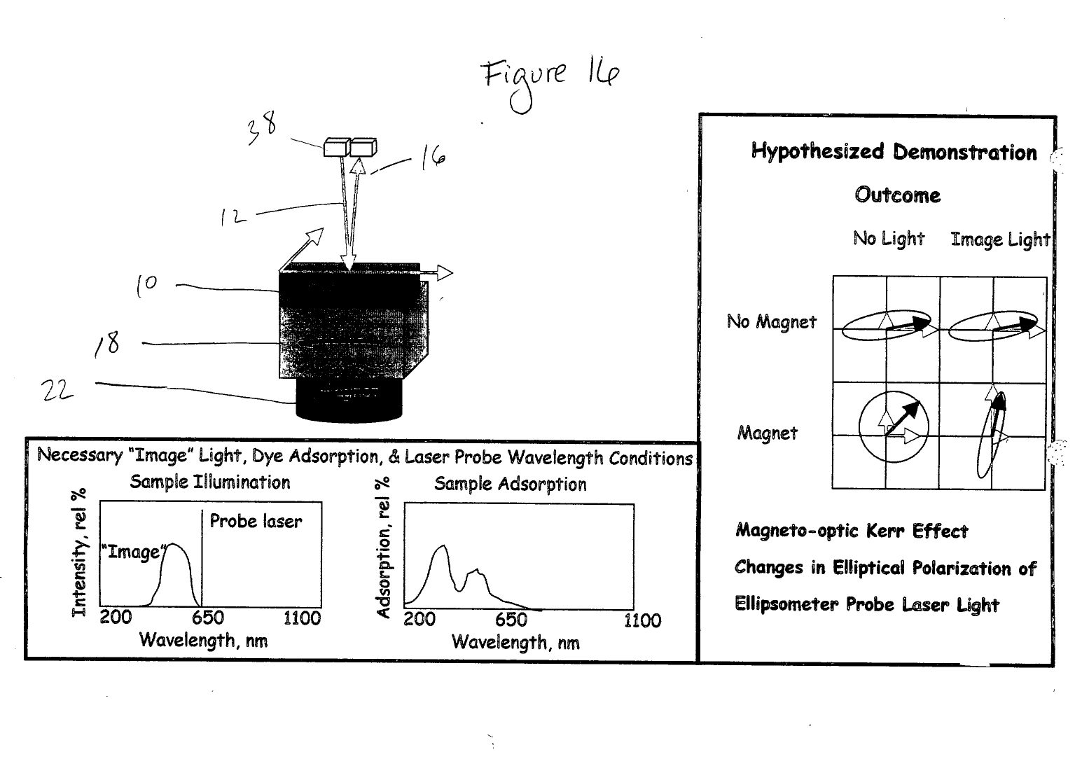

FIG. 15 shows instrumentation and a schematic representing a preferred demonstration approach. The instrumentation shows an MSA on a slide substrate held in place on a stage with magnets mounted below. A reticle and light source is located directly above the array and a probe laser source is aimed toward the MSA. Using this setup, the ellipsometry of the polarized probe light can be demonstrated as in the schematic diagram. Another preferred example of an ellipsometer polarization change demonstration is depicted in FIG. 16. In FIG. 16, the OPSM or thin film layer is placed on a substrate located over a magnet. In this example the substrate is a substantially transparent material allowing the OPSM to be illuminated by back image light. Over the OPSM is a near normal incidence laser beam with a polarizer and its analyzer paths. Arrows show perpendicular polarization and parallel polarization as the beam. Two graphs are shown demonstrating the necessary image light, dye adsorption and laser probe wavelength conditions in the experiment as a result of percent relative intensity and percent relative adsorption. The experimental data results basically demonstrate the magnetooptic Kerr effect changes in elliptical polarization of the ellipsometer probe laser light, as shown in the accompanying graph of image light under conditions with and without a magnet.

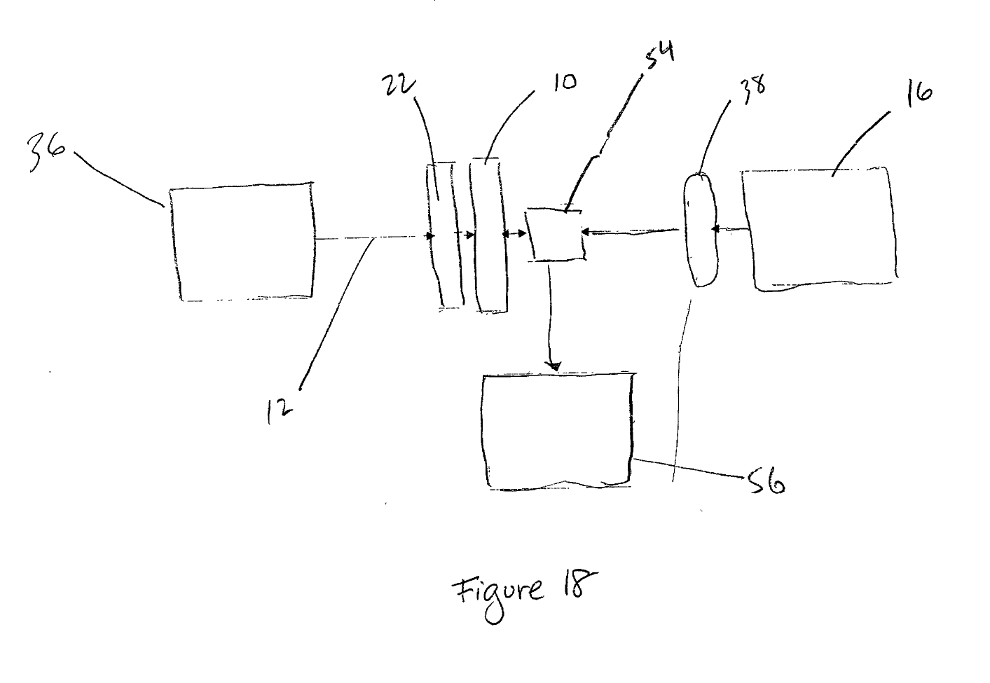

FIG. 18 is a schematic representing another preferred embodiment for testing an MSA system to demonstrate light polarization capabilities of the MSA sensor material. The figure shows a visible light pattern generator. The generator can be something as simple as a light projector connected to a lap top to simulate light from a sample image. In one example, a light pattern generator projecting 16.7 million colors focused to a less than 5 micron spot with a contrast ratio of 400, intensity of 1000 lumens equal to xxx photons per 10 micron square per second on the array. The light beam focuses on a magnet (0.8 Tesla toroidal magnet in this example) and passes through the OPSM coated substrate to a beam splitter. A readout laser, or other light sources such as a light beam through a polarizer source to the same beam splitter. The beam splitter acts as a polarization analyzer and sends the beam to a laser output analyzer which in preferred embodiments is a spectrophotometer photodiode array.

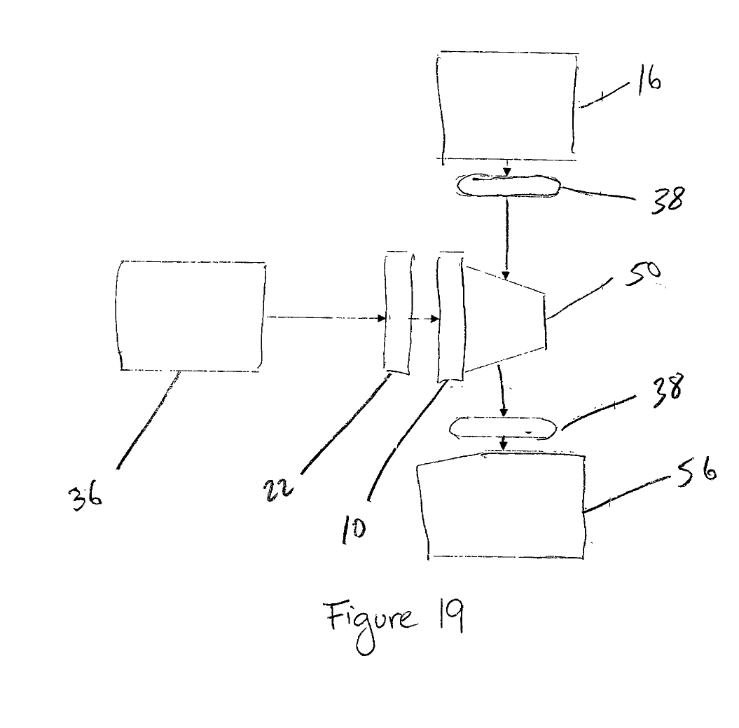

FIG. 19 is a schematic representing yet another preferred embodiment for testing an MSA system to demonstrate light polarization capabilities of the MSA sensor material. This embodiment is very similar to that in FIG. 18, except that a prism is placed over the MSA in place of a beam splitter. This layout requires the use of two polarizers; one between the readout laser or light source and the prism and another polarizer between the prism and the laser output analyzer described above. The prism couples the incoming light to the surface of the OPSM, thus refracting the light towards the thin-film critical angle. This is an example of a setup used to determine the index of refraction of the coated substrate, similarly to the setup shown in FIG. 17, previously discussed. If the coated substrate is a birefringent material, as is desired by the invention, the results will show a difference in refraction i.e. light passing through the coated substrate (OPSM) at a speed different from polarized light passing through at a 90 degree angle.

Applications and Preferred Embodiments

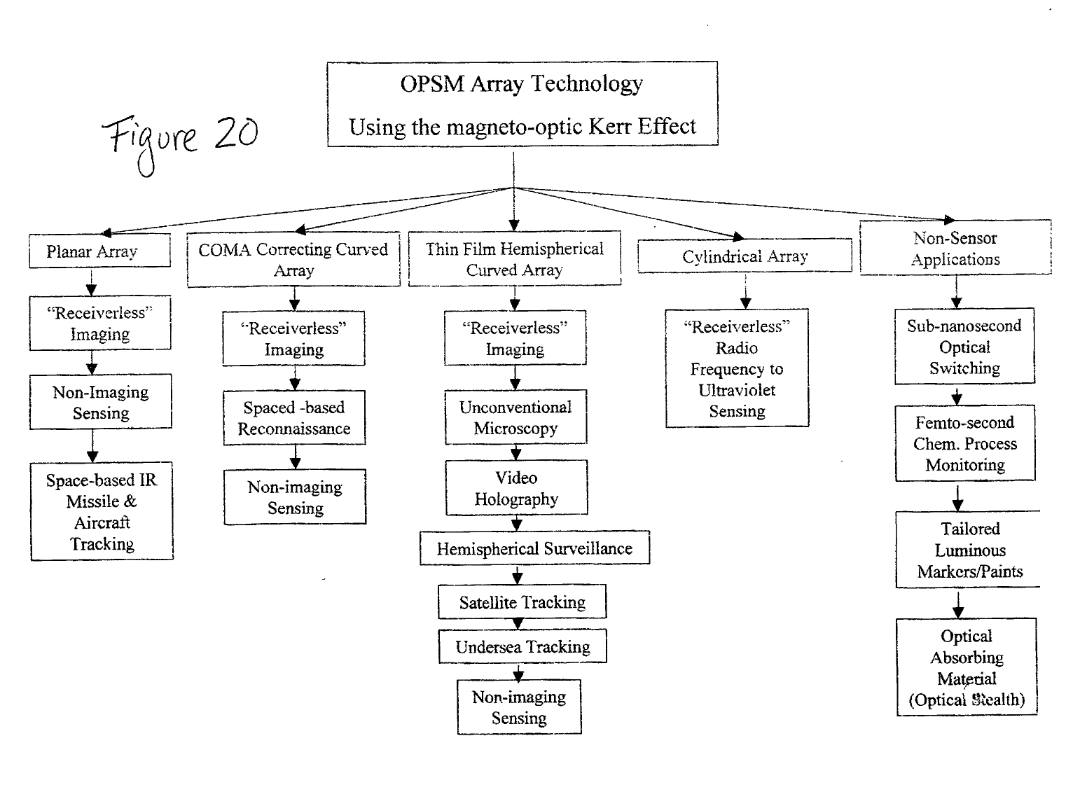

MSA technology enables sensing to be done for a wide variety of applications some of which are depicted in the block diagram of FIG. 20. In a preferred embodiment using a planar array, applications such as “receiverless imaging”, non-imaging sensing and surveillance are possible.

FIG. 10 shows a schematic diagram depicting a preferred embodiment of a receiverless imaging sensing system. This setup allows faster, shorter focal length, wide field of view panchromatic and multispectral imaging (MSI) optics with little or no focal plane electronics. A raster canning readout scans an arbitrarily sized array. The resulting elliptical polarization modulated reflected laser light is the carrier of the image information. No image signal detection is done, hence “receiverless” imaging. This and the nature of the MSA dye-polymer film opens the prospect of much greater near-UV, visible, near-infrared (IR) and mid-IR instantaneous bandwidth than CCDs using silicon (maximum sensitivity approximately at 760 nm in the near-IR for visible imaging illuminated by sunlight with a solar-spectral maximum an 530 nm).

The receiverless imaging eliminates the need for integrated focal plane electronics and cooling. This particularly preferred embodiment creates a sensing system that leads directly to high capacity laser links. Linking the imagery on coherent laser light in turn leads to the prospect of simultaneously processing images and optically processing the imagery phase-shift data for additional information to be overlaid on the images in real time rather than being discovered by specialized nonreal time processing. Moreover, because it does so without analog to digital conversion, higher processing rates can be achieved.

This extraction of added information in upstream processing benefits the process of recording an image, reading it back and parallel processing it to extract pattern recognition information or other additional information as done by end users such as the National Imagery and Mapping Agency. Another advantage to carrying the phase-shift data in the data link or laser downlink, is that reconstruction of the imagery first as a hologram is backward compatible with reimaging the hologram for input to existing ground processing to make a sequential transition to an OPSM space-based imager possible without purchasing a new ground architecture. Beyond this, the elimination of integrated focal plane electronics and cooling increases the mobility of the system and is both efficient and economically advantageous. Considering that at this time the cost of putting a satellite in orbit amount to about thirty thousand dollars per pound, the elimination of the excess electronics and parts amounts to a reduction of several tons and thus can potentially save millions of dollars not to mention savings of about 10 to 100 kilowatts of electricity.

Additionally, the receiverless system allows sampling of data fast enough to allow for applications such as video microscopy as discussed later. Moreover, because a two photon process can be used, the wavelengths used need not be damaging to biological material. The two photon process occurs by pumping two photons of energy, wavelength λ into an absorbing material, very near simultaneously so the OPSM reacts as if excited by λ/2 wavelengths. The appropriate wavelength can be selected for the specific application i.e. so that it is not harmful to the specimen under observation.

A long focal length optical system can support a large imaging plane. In preferred embodiments, it is conceivable that the array has dye molecules or “virtual pixels” for a very large instantaneous field of regard and nearly instantaneous selective imaging of areas with the field. In this embodiment, the elliptically polarized readout laser light is amplified and fed into a modest aperture telescope for transmission to a terrestrial mission ground station. In this preferred embodiment, the re-amplified carrier passes through a retarder/polarizer sandwich to convert the elliptically polarized carrier to an intensity modulated beam. This beam is then split and optically processed to identify desired objects such as identifying manmade features, scanned onto film or EO devices for conversion to existing dissemination systems. Found manmade features could be highlighted or “iconized” and overlaid on product images to assist image analysts.

The amplified scanning laser reflected signal is not truly an analog signal but much like a multi-NRTZ modulated carrier, as it carries information for the long haul through the atmosphere to the downlink. Such carriers have had significant success in links even through atmosphere. This embodiment has the advantage of making all photonic imaging and processing possible.

The particularly preferred embodiments, the MSA includes a nonplanar array. Use of a nonplanar array, among other advantages, provides the ability to sense in several planes simultaneously. Additionally, the use of a nonplanar array is highly suitable for anamorphic optics because the nonplanar array can achieve a wider field of view by correcting formerly unusable image areas and by eliminating corrector optics.

Thus, in one preferred embodiment, the MSA is used as a specialized “smart” array since it does not need to be planar, or uniform across the entire imaging area, or even continuous. Instead, it can be fabricated in various shapes, e.g. wagon wheels, to achieve greater synergy with neural-network techniques or to filter out unwanted shapes or to recognize a specific shape to which it is designed to respond. This allows for customized use of the sensor and for use as part of a screening process that also helps prevent the downlink laser from being overtaxed. This can also be accomplished by altering the raster scan while it is running or by changing the shape of the actively photosensitive areas.

Furthermore, the nonplanar shape of the MSA allows for COMA correction which refers to the distortion that can occur within optical systems when there is oblique incidence; or more specifically correction for aberrations which occur when a bundle of rays forming an image are unsymmetrical due to oblique incidence. The present invention alleviates this distortion problem because the flexibility of the MSA array allows it to be adapted or adjusted to such imperfections—either as a matter of system predesign, or dynamically in real time by feedback servo control. People skilled in the optics field and in the programming field can readily define a protocol for such self-optimization by a system using the invention to match three-dimensional detector surface to a three-dimensional focal surface; roughly analogous to the kind of optimization used for sectional mirrors as in the large astronomical telescopes in Hawaii. Thus, the nonplanar array can be curved and in one preferred embodiment is a COMA correcting curved array that can be applied to the receiverless imaging discussed above, non-imaging sensing and to space-based surveillance or reconnaissance.

In other particularly preferred embodiments, the array is a thin film hemispherical curved array for a wide variety of applications including receiverless imaging, unconventional microscopy, video holography, hemispherical surveillance, satellite and undersea tracking, as well as nonimaging sensing.

In another preferred embodiment of the curved array, the MSA is in a cylindrical form. This embodiment of the array is particularly well adapted for receiverless sensing applications ranging from radio to ultraviolet frequencies.

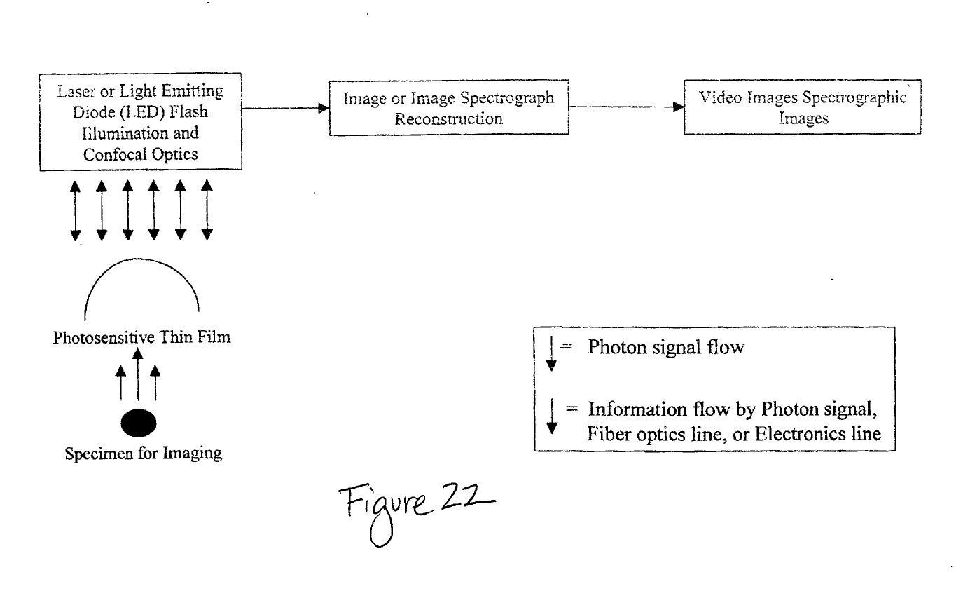

In preferred embodiments for nonsensor applications, the OPSM can be used to detect and monitor chemical processing that occurs at speeds on a femtosecond range as described in more detail in FIG. 22. This embodiment can also be applied to sense subnanosecond optical switching (from 10 to 100 picoseconds) that can be used with an instant image magnetometer or can be used in microscopy to track artificial macromolecules, or even to track light being generated by living organisms or chemical reactions under a microscope. In addition, the MSA boasts low light level needs, perhaps even moonless night may provide enough depending on the application, as well as use with a shorter, lighter optical system. These embodiments are possible because the MSA causes electrooptical imaging and sensing to become optical to optical imaging without tedious conversions for electronics. This is so because it uses higher image photon flux long-dwell imaging, direct focal plane to laser link (photon to photon) or receiverless readout that does not require focal plane electronics. Basically the invention provides for instantaneous and simultaneous ground processing for imagery and feature detection without disadvantages such as earth rotation smear. Moreover, it is easily combined with current ground electronics to record sampled images and the images are growable to mega frames pers second. Even video, stop motion or fast phenomena imaging can be used with it.

Other preferred embodiments of the OPSM for use without a magnetic field include use of the material for tailored luminous markers and paints or as an optical absorbing material for optical stealth applications such as for use on missiles and aircraft. This category basically refers to the use of dye materials that can be applied to stealth, unseen tags, specialized paints and transmissive coatings. These dye materials as used in the OPSM are basically light absorbing materials that can be tuned to absorb more or less light depending on the selected dye ingredients. These materials take advantage of the light absorbing properties of the OPSM layer and for these applications a magnetic field is no longer necessary. For these applications, a 20 nanometer thick layer of tightly packed OPSMs uniformly arranged within about 5 nanometers or closer is required. These dimensions are necessary because this application is based on the Fortzner effect. If fluorescent dye molecules are packed together very closely, they emit very little or no energy in the form of light. The energy in the molecules passes from one dye molecule to another with a quantum efficiency that approaches one hundred percent. The only energy that is dissipated, if at all is due to molecular collisions or in the form of heat. As a result, in this type of tightly packed dye molecules in thin layers within the OPSMs' substantially seamless array, the photon energy is absorbed into the electron p orbitals around the dye and the energy changes form into thermal energy instead of being reflected back as light. In other words, the OPSMs can be used as coating that absorb photons without reradiating light for applications such as coating the inside of camera baffles, telescopes, or other instruments or where there are needs for such coating due to low ambient light levels such as night vision goggles.

While OPSMs can be used as coatings that absorb photons without reradiating light, it is also important to note that based on the selection of the dye materials, the OPSM coatings can be applied to other applications as well. Using broadband dyes or a mixture of dyes makes these sensor multispectral, thus by combining multiple types of dyes in a single OPSM layer, such coatings can be applied to select for and for sensor use with video frame rate, visible color and near Ir wavelengths. This ability of the OPSM to absorb light of a particular wavelength allows it to be used as a marker or a tag in the form of a paint, or paint-like substance that can be combined with other tagging systems such as bar coding.

FIG. 21 is a block diagram representing instrumentation and steps used for surveillance applications of the MSA. The surveillance applications include, but are not limited to underwater surveillance including from a water vessel e.g. boat or submarine looking down or outward in any direction, airborne marine surveillance and air and space surveillance including a sensor on a heavenly body e.g. moon, satellites, or a sensor in orbit, focusing up toward or into space in any direction. In these applications the sensor can be employed to detect moving targets such as satellites, asteroids, planets, comets, missiles, debris or moving targets with significant polarizations such as many man-made objects and submerged systems.

FIG. 22 is a block diagram representing a preferred MSA embodiment for extremely fast (femtosecond scale) serial imaging with or without optics. In this embodiment, microscopic video images or spectrograph can be reconstructed from the capability to scan a surface so rapidly that acquisition of individual image photon amplitude and phase data is made possible. The curved hemispherical shape of the thin film MSA allows the sensor to curve around an object and thus simultaneously read information regarding all three dimensions of the object. A laser or LED is pulsed on/off to determine where light hits the array at a given time and the resulting light pattern can be transformed into an electrical signal by using a diode as in the figure. The frame rate is only limited by reconstruction processing. The frame shutter speed is limited only by bandwidth of the image information storage buffer. This type of imaging is particularly applicable to sense direct-records of physical, chemical and biological interactions.

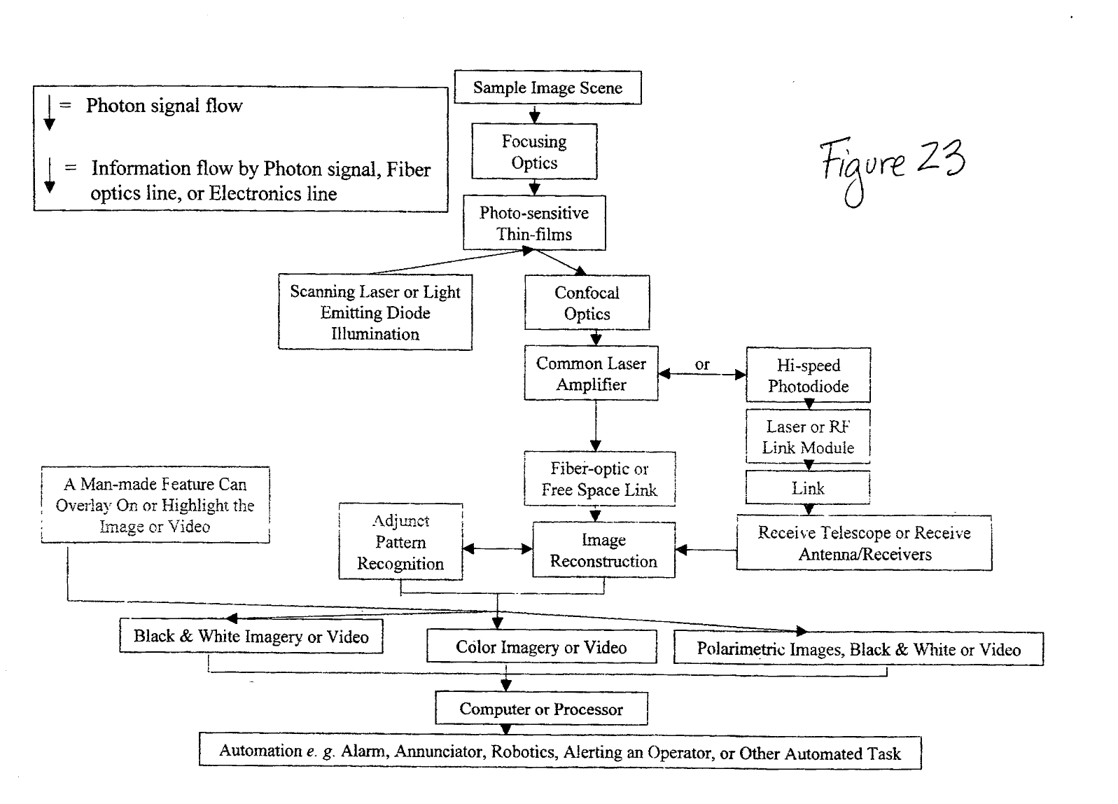

FIG. 23 is a block diagram representing another preferred embodiment of the invention as an electronics-free replacement for any camera, telescope, reconnaissance or surveillance system for eyesight augmentation. This embodiment, is similar to the surveillance application in FIG. 22. It also shows that identifying means such as adjunct pattern recognition can be applied. This basically refers to screening for a specific pattern and can be automated or linked to a man-made feature such as video or image clip to be overlaid on the reconstructed image. The received downlink can be split to permit simultaneous processing for a number of custom outputs.

In a preferred embodiment, when the laser beam is received by a station it can be combined with a laser reference beam to produce a holographic image. For backward compatibility, the holographs can be conventionally reimaged. Moreover, since the received downlink is light, it could also be split to permit simultaneous processing for a number of custom outputs.

Thus, in another preferred embodiment, the received downlink is optically processed against a number of filters for feature detection of straight edges, corners, etc. that indicate or screen for man-made objects in the image or compared with prior imagery for change detection. Then information from each of the simultaneously processed streams could be superimposed on the principal processed image to automatically overlay value added information or change detection. This preferred feature can be used with any of the MSA surveillance applications but is a preferred embodiment shown in FIG. 23.

Furthermore, comparing the MSA “pixels” to traditional sensor pixels highlights the speed and simplicity of an MSA system. OPSMs provide submicron pixel size with 12-bit electron well depth to replace traditional focal plane arrays. Thus, OPSMs accumulate relatively fewer electrons at a time compared to traditional sensors such as CCD's but OPSMs measure electrons at regular and more frequent intervals on a per microsecond basis. These interval measurements are made by sweeping light emission e.g. by the raster scanner and allow the sensor to accumulate relatively more statistically accurate imaging information and to use faster frame rates. As a result, an array of densely packed OPSMs has the potential to replace present planar photosensor CCD arrays, making changes in imagery intelligence (IMINT) greater than the transition from film-return to electrooptical digital systems.

There are many applications of the OPSM as a coating material and as a molecular sensing array as discussed above. The MSA system also allows many imaging options such as broadband applications due to the increased bandwidth, low light level due to the higher photon flux, imaging in the UV, visible and Mid IR wavelengths by using multiple dyes, still and video imaging. Given the great versatility of the MSA and its broad range of application, it has relevance to numerous industries including but not limited to high end research in industrial, imaging or photography, chemical, medical and biotechnology fields as well as the defense and aerospace industries. Also given its numerous advantages over prior art semiconductor based devices such as CCD's and CID, the MSA can readily be used to replace these devices in most applications, thus providing a lightweight and economical alternative to such area and linear image sensors.

Accordingly, the present invention is not limited to the specific embodiments illustrated herein. Those skilled in the art will recognize, or be able to ascertain that the embodiments identified herein and equivalents thereof require no more than routine experimentation, all of which are intended to be encompassed by claims.

What is claimed is:

1. An optical phase-shift material; said material comprising:
photon-energized electrons interacting with a magnetic field;
a dye film supplying the photoelectrons; and
a substrate surface for supporting the dye film.

2. The material of claim 1, further comprising insulation, wherein the insulation comprises:
means for electron blocking.

3. The material of claim 2, wherein:
the electron-blocking means are located within interstitial space of the material.

4. The material of claim 2, wherein:
the electron-blocking means comprise nitrogen-containing polymers.

5. The material of claim 1, wherein:
the dye film is a photosensitive thin film.

6. The material of claim 1, wherein:
the dye film is a multilayer photosensitive thin film.

7. The material of claim 1, wherein:
the dye film has magnetooptical properties.

8. The material of claim 7, wherein:
the magneto-optical properties comprise means for causing birefringence.

9. The material of claim 7, wherein:
the magneto-optical properties comprise a capability for changing ellipticity of polarization of a probing light beam.

10. The material of claim 1, wherein:
the material is sensitive to incoming light in visible, ultraviolet and infrared spectral regions.

11. The material of claim 1, wherein:
the dye comprises ferromagnetic atoms.

12. The material of claim 1, wherein:
the material is coated on a nonplanar surface.

13. The material of claim 1, wherein:
the substrate is substantially transparent.

14. The material of claim 1, wherein:
the substrate surface is selected from the group consisting of polished metal, glass, quartz, and plastic.

15. The material of claim 1, wherein:
the substrate surface comprises one or more microscopic particles.

16. The material of claim 1, wherein:
the substrate surface comprises means defining one or more cavities.

17. The material of claim 1, wherein:
the substrate surface surrounds the dye film, forming dye microdroplets.

18. The material of claim 1, wherein the dye film is selected from the group consisting of:
pthalocyanines, porphyrins, anthraquinones and perylene derivatives.

19. The material of claim 1, wherein the dye film is selected from the group consisting of:
silver nanoparticles with anthraquinone, silver nanoparticles with quinizarin, silver nanoparticles with 1,4 diamnoanthraquinone, silver nanoparticles with oil blue, zinc pthalocyanine, perylene, zinc 2,3,910,16,17,23,24-octakis(octyloxy)-29H,31H-phthalocyanine, iron(II)phthalocyanine, protoporphyrin IX iron(III), 5,10,15,20-tetraphenyl-21H,23H-porphine iron(III)chloride, 5,10,15,20-tetraphenyl-21H,23H-porphine cobalt(III), oil blue, quiniarin 1,4-dihydroxyanthraquinone, and N,N′-ditridecyl-3,4,9,10-perylenetetracarboxylic diimide.

20. The material of claim 1, further comprising:
means for relaxation.

21. The material of claim 20, wherein the relaxation means comprise:
holes recapturing the photon-energized electrons after the electrons enter a higher energy state.

22. The material of claim 20, wherein:
the relaxation means substantially restore the material to an initial energy state.

23. The material of claim 20, wherein:
the relaxation means substantially restore the material within a time period on the order of 100 microseconds.

24. The material of claim 20, wherein:
the relaxation means substantially restore the material in a time period on the order of 10 microseconds.

25. A sensing system, said system comprising:
an optical phase-shift material;
means for exposing the optical phase-shift material to a light pattern; and
means for detecting a resulting optical-phase shift by the material.

26. The system of claim 25, wherein the detecting means comprise:
means for producing a light beam phase-shifted by the material; and
a data link transmitting the phase-shifted beam.

27. The system of claim 26, wherein:
the producing means derive the phase-shifted beam from interaction of a reading beam and the material directly, with no intervening electronic stage.

28. The system of claim 27, wherein the producing means comprise:
means for imposing a magnetic field on the material to interact with the material and produce the phase shift.

29. The system of claim 28, wherein the producing means comprise:
means for directing a readout beam to the material, to be phase shifted by the material.

30. The system of claim 29, wherein:
the readout beam is a beam from a laser or light-emitting diode.

31. The system of claim 28, wherein:
the magnetic field produces a force on energetic electrons, wherein the force causes elliptical polarization of light reflected from the readout laser beam.

32. The system of claim 29, wherein:
the directing means comprise means for a raster scanning the laser beam.

33. The system of claim 29, wherein:
the directing means comprise means for intensity modulating the laser beam.

34. The system of claim 29, particularly for use as an imaging system; and wherein:
the laser beam is detected and applied to reconstruct an image carried in said light pattern.

35. The system of claim 30, wherein:
the scanning laser beam substantially instantaneously reads and transmits desired portions of the image.

36. The system of claim 33, wherein:
the directing means further comprise means for adjusting scan rates of the scanning laser beam to aid image motion compensation and smear reduction.

37. The system of claim 26, wherein the data link comprises:
a downlink from a space-based module to a planetary station or a near-planetary vehicle.

38. The system of claim 37, wherein the downlink comprises:
means for amplifying, expanding and collimating the phase-shifted beam.

39. The system of claim 38, wherein:
the expansion means and collimation means comprise a telescope for expanding and collimating the readout transmission.

40. The system of claim 25, further comprising:
means for optical processing of the phase-shifted beam.

41. The system of claim 40, wherein:
the processing means comprise means for identifying objects.

42. The system of claim 41, wherein:
the identifying means comprise means for identifying particular objects.

43. The system of claim 42, wherein:
the objects comprise manmade objects.

44. The system of claim 25, further comprising:
means for processing the resulting image light to present.

45. The system of claim 44, wherein:
the processing means comprise means for annotating the resulting image light.

46. The system of claim 25, further comprising:
automatic means for monitoring resulting image light; wherein the monitoring means are selected from the group consisting of:
an annunciator for alerting an operator to the resulting image light,
an alarm for alerting an operator to the resulting image light;
robotics for carrying out an appropriate response to the resulting image light; and
an automated task performed in response to the resulting image light.

47. The system of claim 25, for use in surveillance, said system further comprising:
optics for focusing light emanating from a desired image;
means for reading and transmitting the resulting image light;
confocal scanning means for transmitting light to a photodiode or an amplifier;
means for amplifying the resulting image light;
transmission means comprising the data link;
means for reconstructing or analyzing the light pattern;
means for receiving and displaying the resulting image light;
means for processing the resulting image; and
automatic means for monitoring the resulting image and providing an appropriate response.

48. The system of claim 47, wherein the reading and transmitting means are selected from the group consisting of:
a scanning laser; and
a light-emitting diode illumination.

49. The system of claim 47, wherein the amplification means comprise:
a laser telescope amplifier;
means for transmitting the light pattern, said transmitting means being selected from the group consisting of:
a free space link; and
fiber optics; and
means for receiving the transmitted light pattern; said receiver being selected from the group consisting of:
a receiver telescope; and
a fiber optics receiver.

50. The system of claim 49, wherein the transmitting means comprise:
an avalanche high-speed photodiode; and
means selected from the group-consisting of:
a modulator;
a free space link;
fiber optics; and
an electronics line.

51. The system of claim 49, wherein the receiving and displaying means comprise means for forming images selected from the group consisting of:
panchromatic images;
color images;
polarimetric images; and
video images.

52. The system of claim 25, particularly for forming multiple images in a time series; said system further comprising:
means for reading and transmitting the resulting image light;
confocal optics for transmitting the light;
means for reconstructing or analyzing the light pattern; and
means for receiving the resulting image light.

53. The system of claim 52, wherein the reading and transmitting means are selected from the group consisting of:
a scanning laser; and
a light-emitting diode illumination.

54. The system of claim 52, wherein the receiving means comprise means for forming images selected from the group consisting of:
panchromatic images;
color images;
polarimetric images;
spectrographic images; and
video images.

55. The system of claim 25, wherein:
the material comprises an array.

56. The system of claim 55, wherein:
the array is substantially seamless.

57. The system of claim 25, wherein:
the material is coated on a curved surface.

58. The system of claim 55, wherein:
the array is at a focal-surface array.

59. The system of claim 55, wherein:
the array has an f/number roughly 1, or smaller.

60. The system of claim 55, wherein:
the array is cylindrical and is for use in receiverless sensing comprising radio frequency to ultraviolet wavelength sensing.

61. The system of claim 25, wherein:
the material comprises one or more dye molecules.

62. The system of claim 61, wherein:
the dye molecules comprises comprise pixels.

63. The system of claim 62, wherein:
the pixels are electrostatically localized in an array.

64. The system of claim 62, wherein:
the pixels are reproducibly arranged in the array.

65. The system of claim 62, wherein:
the pixels are smaller than light wavelengths emanating from an object to be imaged.

66. The system of claim 62, wherein:
the pixels are of an order 10 nanometers in size.

67. The system of claim 62, wherein:
the pixels are aligned to polarize light.

68. The system of claim 62, wherein:
the pixels are oriented perpendicularly to the magnetic field.

69. The system of claim 25, wherein:
the material is for use in optical switching.

70. The system of claim 69, wherein:
the optical switching comprises sub-nanosecond optical switching.

71. The system of claim 25, wherein:
the material is for use in chemical-process monitoring.

72. The system of claim 71, wherein:
the chemical-process monitoring comprises femtosecond chemical-process monitoring.

73. The system of claim 25, wherein:
the material is used as an optical absorber for optical stealth applications.

74. The system of claim 73, wherein the optical stealth applications are selected from the group consisting of:
missile technology,
aerospace technology,
aviation technology,
film technology,
video technology,
stealth technologies; and
securities industries.

75. A sensing method, said sensing method comprising the steps of:
selecting one or more photoelectric dyes;
ordering layers of a film comprising the photoelectric dyes;
coating a substrate with the film;
configuring the substrate into an array;
exposing the array to a light pattern; and
detecting a resulting optical phase shift by the array.

76. The method of claim 75, further comprising the step of:
optimizing the dye film for use with particular wavelengths of imaged light by choice of film properties selected from the group consisting of:
film thickness,
film density,
film cross-sectional area,
ionizable electrons per molecule,
spectral reflectivity and absorptivity, and
angle of molecular orientation to the substrate.

77. The method of claim 75, further comprising the steps of:
producing a light beam phase-shifted by the array; and
transmitting the phase-shifted beam as a data link.

78. The method of claim 77, further comprising the step of:
deriving the phase-shifted beam from interaction of a reading beam and the array directly with no intervening electronic stage.

79. The method of claim 78, wherein:
the reading beam is a laser or light-emitting diode.

80. The method of claim 78, particularly for use as an imaging method; further comprising the steps of:
detecting the laser beam; and
applying the laser beam to reconstruct an image carried in said light pattern.

81. The method of claim 75, further comprising the steps of:
imposing a magnetic field on the array to interact with the array and produce the phase-shift.

82. The method of claim 78, further comprising the step of:
producing a magnetic field force on energetic electrons, wherein the force causes elliptical polarization of a light reflected from the reading beam.

83. The method of claim 78, further comprising the step of:
raster scanning the reading beam.

84. The method of claim 83, further comprising the step of:
adjusting scan rates of the scanning laser beam to aid image motion compensation and smear reduction.

85. The method of claim 78, further comprising the step of:
intensity modulating the laser beam.

86. The method of claim 75, further comprising the steps of:
amplifying, expanding and collimating the phase-shifted beam.

87. The method of claim 75, further comprising the step of:
optically processing the phase-shifted beam.

88. The method of claim 87, wherein the processing step comprises the step of:
identifying particular objects.

89. The method of claim 88, wherein:
the objects comprise man-made objects.

90. The method of claim 88, wherein the processing step comprises:
processing the resulting image light to present.

91. The method of claim 75, further comprising the steps of:
automatically monitoring resulting image light; wherein the monitoring is selected from the group consisting of:
annunciating the resulting optical phase shift;
alerting an operator to the resulting optical phase shift;
robotically carrying out an appropriate response to the resulting optical phase shift; and
automatically performing a task in response to the resulting optical phase shift.

92. A molecular sensing array preparation method, said method comprising the steps of:
selecting one or more photoelectric dyes;
ordering layers of a film comprising the photoelectric dyes;
coating a substrate with the film; and
configuring the substrate into an array.

93. The method of claim 92, further comprising the step of:
optimizing the dye film for use with particular wavelengths of imaged light by choice of film properties selected from the group consisting of:
film thickness,
film density,
film cross-sectional area,
ionizable electrons per molecule,
spectral reflectivity and absorptivity, and
angle of molecular orientation to the substrate.

94. A test method for testing an optical-phase shift based imaging system; said method comprising the steps of:
exposing an optical phase-shift material to a light beam;
locating the material in a rotating mechanism placed perpendicularly to the incoherent light;
incrementally rotating the exposed material;
exposing a polarizer to a resulting light beam; and
detecting the resulting light beam.

95. The test method of claim 94, further comprising the step of:
locating a magnet in the rotating mechanism; and
exposing the material to the magnet.

96. The test method of claim 94, wherein:
the light beam is a light source selected from the group consisting of:
an incandescent light, a light-emitting diode and a laser.

97. The test method of claim 94, wherein:
the polarizer is an analyzing polarizer.

98. The test method of claim 94, further comprising the step of:
exposing a polarizing filter to the light beam.

99. The test method of claim 94, further comprising the step of:
exposing the light beam to a prism located on the material and perpendicularly to the beam.
